(19) United States
(12) Patent Application Publication
(10) Pub. No.: US 2026/0223190 A1
(43) Pub. Date: Jul. 30, 2026

(54) MOBILE-TERMINATED SMALL DATA TRANSFER

(71) Applicant: QUALCOMM Incorporated, San Diego, CA (US)

(72) Inventors: Ruiming ZHENG, Beijing (CN); Masato KITAZOE, Hachiouji-shi (JP); Ozcan OZTURK, San Diego, CA (US); Shankar KRISHNAN, Poway, CA (US)

(21) Appl. No.: 19/147,205

(22) PCT Filed: Feb. 15, 2023
(86) PCT No.: PCT/CN2023/076130

§ 371 Date: Jul. 10, 2025

(51) Int. Cl. H04W 74/0833

(52) U.S. Cl. CPC H04W 74/0833

(57) ABSTRACT

Various aspects of the present disclosure generally relate to wireless communication. In some aspects, a user equipment (UE) may receive a configuration indicating at least one of: a first random access (RA) resource, or a second RA resource configured for a mobile-originated small data transfer (MO-SDT). The UE may receive, from a paging message, an indication of a mobile-terminated SDT (MT-SDT). The UE may select an RA resource, in accordance with the configuration, for an MT-SDT RA channel (RACH) transmission, wherein selecting the RA resource is based at least in part on whether a set of conditions associated with MO-SDT reception are satisfied. The UE may transmit the MT-SDT RACH transmission on the selected RA resource. Numerous other aspects are described.

### FIELD OF THE DISCLOSURE

Aspects of the present disclosure generally relate to wireless communication and to techniques and apparatuses for mobile-terminated small data transfer (MT-SDT).

### BACKGROUND

Wireless communications systems are widely deployed to provide various telecommunication services such as telephony, video, data, messaging, broadcasts, or other similar types of services. These wireless communications systems may employ multiple-access technologies capable of supporting communications with multiple users by sharing available wireless communications system resources with those users.

Although wireless communications systems have made great technological advancements over many years, challenges still exist. For example, complex and dynamic environments can still attenuate or block signals between wireless transmitters and wireless receivers. Accordingly, there is a continuous desire to improve the technical performance of wireless communications systems, including, for example: improving speed and data carrying capacity of communications, improving efficiency of the use of shared communications mediums, reducing power used by transmitters and receivers while performing communications, improving reliability of wireless communications, avoiding redundant transmissions and/or receptions and related processing, improving the coverage area of wireless communications, increasing the number and types of devices that can access wireless communications systems, increasing the ability for different types of devices to intercommunicate, increasing the number and types of wireless communications mediums available for use, and the like. Consequently, there exists a need for further improvements in wireless communications systems to overcome the aforementioned technical challenges and others.

### SUMMARY

Some aspects described herein relate to a method of wireless communication performed by a user equipment (UE). The method may include receiving a configuration indicating at least one of, a first random access (RA) resource, or a second RA resource configured for a mobile-originated small data transfer (MO-SDT). The method may include receiving, from a paging message, an indication of a mobile-terminated SDT (MT-SDT). The method may include selecting an RA resource, in accordance with the configuration, for an MT-SDT RA channel (RACH) transmission, wherein selecting the RA resource is based at least in part on whether a set of conditions associated with MO-SDT reception are satisfied. The method may include transmitting the MT-SDT RACH transmission on the selected RA resource.

Other aspects provide: an apparatus operable, configured, or otherwise adapted to perform any one or more of the aforementioned methods and/or those described herein with reference to and as illustrated by the drawings; a non-transitory, computer-readable medium comprising computer-executable instructions that, when executed by a processor of an apparatus, cause the apparatus to perform the aforementioned methods and/or those described herein with reference to and as illustrated by the drawings; a computer program product embodied on a computer-readable storage medium comprising code for performing the aforementioned methods and/or those described herein with reference to and as illustrated by the drawings; and/or an apparatus comprising means for performing the aforementioned methods and/or those described herein with reference to and as illustrated by the drawings. By way of example, an apparatus may comprise a processing system, a device with a processing system, or processing systems cooperating over one or more networks.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages, will be better understood from the following description when considered in connection with the accompanying figures. Each of the figures is provided for the purposes of illustration and description, and not as a definition of the limits of the claims.

While aspects are described in the present disclosure by illustration to some examples, those skilled in the art will understand that such aspects may be implemented in many different arrangements and scenarios. Techniques described herein may be implemented using different platform types, devices, systems, shapes, sizes, and/or packaging arrangements. For example, some aspects may be implemented via integrated chip embodiments or other non-module-component based devices (e.g., end-user devices, vehicles, communication devices, computing devices, industrial equipment, retail/purchasing devices, medical devices, and/or artificial intelligence devices). Aspects may be implemented in chip-level components, modular components, non-modular components, non-chip-level components, device-level components, and/or system-level components. Devices incorporating described aspects and features may include additional components and features for implementation and practice of claimed and described aspects. For example, transmission and reception of wireless signals may include one or more components for analog and digital purposes (e.g., hardware components including antennas, radio frequency (RF) chains, power amplifiers, modulators, buffers, processors, interleavers, adders, and/or summers). It is intended that aspects described herein may be practiced in a wide variety of devices, components, systems, distributed arrangements, and/or end-user devices of varying size, shape, and constitution.

### BRIEF DESCRIPTION OF THE DRAWINGS

So that the above-recited features of the present disclosure can be understood in detail, a more particular description, briefly summarized above, may be had by reference to aspects, some of which are illustrated in the appended drawings. It is to be noted, however, that the appended drawings illustrate only certain typical aspects of this disclosure and are therefore not to be considered limiting of its scope, for the description may admit to other equally effective aspects. The same reference numbers in different drawings may identify the same or similar elements.

FIG. 1 depicts an example of a wireless communications network, in accordance with the present disclosure.

FIG. 2 depicts aspects of an example base station (BS) and user equipment (UE), in accordance with the present disclosure.

FIG. 3 depicts an example disaggregated base station architecture.

FIGS. 4A, 4B, 4C, and 4D depict aspects of data structures for a wireless communications network in accordance with the present disclosure.

FIGS. 5A-5C are diagrams illustrating examples of mobile-originated small data transmission (MO-SDT) procedures, in accordance with the present disclosure.

FIGS. 6A-6C are diagrams illustrating examples of mobile-terminated small data transmission (MT-SDT) procedures, in accordance with the present disclosure.

FIG. 7 is a diagram illustrating an example of signaling associated with uplink data transmission in an MT-SDT, in accordance with the present disclosure.

FIG. 8 is a diagram illustrating an example of signaling associated with uplink data transmission in an MT-SDT, in accordance with the present disclosure.

FIG. 9 is a diagram illustrating an example of random access (RA) resource selection for an MT-SDT, in accordance with the present disclosure.

FIG. 10 shows a method for wireless communications by a UE.

FIG. 11 is a diagram illustrating an example of an implementation of code and circuitry for a communications device, in accordance with the present disclosure.

### DETAILED DESCRIPTION

Aspects of the present disclosure provide apparatuses, methods, processing systems, and computer-readable mediums for mobile-terminated small data transfer (MT-SDT).

SDT provides a way for a UE to transmit or receive information to or from a network without entering a radio resource control (RRC) active state. SDT communication (and non-SDT communication) may utilize radio bearers, such as data radio bearers (DRBs) or signaling radio bearers (SRBs). Uplink data of the UE may be referred to as uplink SDT data (if the uplink data is mapped to a DRB configured for SDT, which may be handled in mobile-originated SDT (MO-SDT)) or as uplink non-SDT data (if the uplink data is not mapped to any DRB configured for SDT in an ongoing SDT procedure). A field may indicate uplink non-SDT data arrival at the UE. If a random access SDT (RA-SDT) resource is selected for MT-SDT, the network may be informed of the presence of uplink data during an SDT based on the resource type selection (which may be considered an implicit indication), and thus the network may provide a larger uplink grant for the UE to report a buffer status report (BSR), so that the UE can be scheduled for the subsequent uplink data.

However, legacy approaches for SDT may not provide a scheduling request (SR) resource for SDT, so a BSR cannot be sent outside of an SDT RACH transmission (e.g., Msg3 or MsgA for RA-SDT). If a legacy RA resource (e.g., a first RA resource) is selected for MT-SDT, it may be unclear to the network whether the UE has newly arrived uplink data in an ongoing MT-SDT. Furthermore, if the uplink data arrives after transmission of the SDT RACH transmission, the UE may not be capable of providing a BSR outside of the SDT RACH transmission due to the lack of an SR resource for SDT. Thus, the network may fail to provide a grant for transmission of the uplink data, thereby increasing the latency and signaling overhead for handling the arrived UL data since the UE may need to enter an RRC connected state to transfer the data.

Some techniques described herein provide indication of the presence of uplink data during an MT-SDT. In some aspects, the uplink data arrives prior to transmission of a Msg3 or MsgA of the MT-SDT procedure, and the indication of the presence of the uplink data can be provided via the SDT RACH transmission. In some other aspects, the uplink data arrives after the transmission of the Msg3 or MsgA, and the UE may use another form of signaling (e.g., UE assistance information, an SR, a BSR, or a combination thereof) to trigger provision of resources on which the uplink data can be transmitted. Thus, uplink data can be delivered during an RRC inactive state with limited overhead and latency by providing resources for transmission of uplink data during an MT-SDT.

A UE may be permitted to initiate an SDT (e.g., an MO-SDT) if a set of conditions associated with an MO-SDT are satisfied. The set of conditions may include one or more of: all pending data in the uplink being mapped to radio bearers configured for SDT; data volume of the pending uplink data across all radio bearers configured for SDT being less than or equal to a configurable threshold (e.g., sdt-DataVolumeThreshold); and the reference signal received power (RSRP) of the downlink pathloss reference being higher than a threshold (e.g., sdt-RSRP-Threshold). During an MT-SDT, the UE may select a first RA resource for MT-SDT, and may select a second RA resource if the set of conditions associated with MO-SDT are satisfied. For example, the UE may only select a second RA resource if the set of conditions associated with MO-SDT are satisfied.

As mentioned above, a UE may receive an indication of an MT-SDT in a paging message. Thereafter, the UE may perform an MT-SDT procedure. For example, the UE may trigger the MT-SDT after receiving the indication, and may transmit a RACH preamble and/or perform subsequent RACH communications on a selected RA resource. However, some RA resources (e.g., first RA resources described above) may not involve the UE checking a set of conditions associated with MO-SDT as a pre-condition for selecting the RA resources, whereas other RA resources (e.g., second RA resources described above) may require the UE to check the set of conditions associated with MO-SDT as a pre-condition for selecting such RA resources for the RACH preamble and/or subsequent RACH communications. Therefore, it may be unclear whether or not the UE should check the set of conditions associated with MO-SDT before transmitting an RRC resume request including the MT-SDT indication (e.g., the MT-SDT resume cause). This ambiguity may lead to failure to utilize certain SDT resources and inefficiency in configuration of RA resources. Furthermore, in some aspects, it may be unclear how the UE is to select RACH resources for MT-SDT (e.g., whether first RA resources and/or second RA resources can be used for MT-SDT), leading to ambiguity in configuration of RA resources and decreased efficacy of MT-SDT.

Some techniques described herein provide selection of RA resource for MT-SDT based at least in part on whether a set of conditions associated with MO-SDT are satisfied. For example, the UE may select the RA resource prior to transmission of an MT-SDT RACH transmission (e.g., a RACH Msg3 including an RRC resume request with an MT-SDT indication). Thus, ambiguity regarding whether to check the set of condition associated with MO-SDT prior to transmission of the MT-SDT RACH transmission is resolved, thereby improving utilization of certain SDT resources and improved efficiency in configuration of RA resources. Furthermore, some techniques described herein provide configuration of RACH resources specific to MT-SDT (referred to herein as third RA resources or RA-MT-SDT resources), which reduces ambiguity in configuration of RA resources and increases efficacy of MT-SDT.

Various aspects of the disclosure are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. One skilled in the art should appreciate that the scope of the disclosure is intended to cover any aspect of the disclosure disclosed herein, whether implemented independently of or combined with any other aspect of the disclosure. For example, an apparatus may be implemented or a method may be practiced using any number of the aspects set forth herein. In addition, the scope of the disclosure is intended to cover such an apparatus or method which is practiced using other structure, functionality, or structure and functionality in addition to or other than the various aspects of the disclosure set forth herein. It should be understood that any aspect of the disclosure disclosed herein may be embodied by one or more elements of a claim.

Several aspects of telecommunication systems will now be presented with reference to various apparatuses and techniques. These apparatuses and techniques will be described in the following detailed description and illustrated in the accompanying drawings by various blocks, modules, components, circuits, steps, processes, algorithms, or the like (collectively referred to as “elements”). These elements may be implemented using hardware, software, or combinations thereof. Whether such elements are implemented as hardware or software depends upon the particular application and design constraints imposed on the overall system.

While aspects may be described herein using terminology commonly associated with a 5G or New Radio (NR) radio access technology (RAT), aspects of the present disclosure can be applied to other RATs, such as a 3G RAT, a 4G RAT, and/or a RAT subsequent to 5G (e.g., 6G).

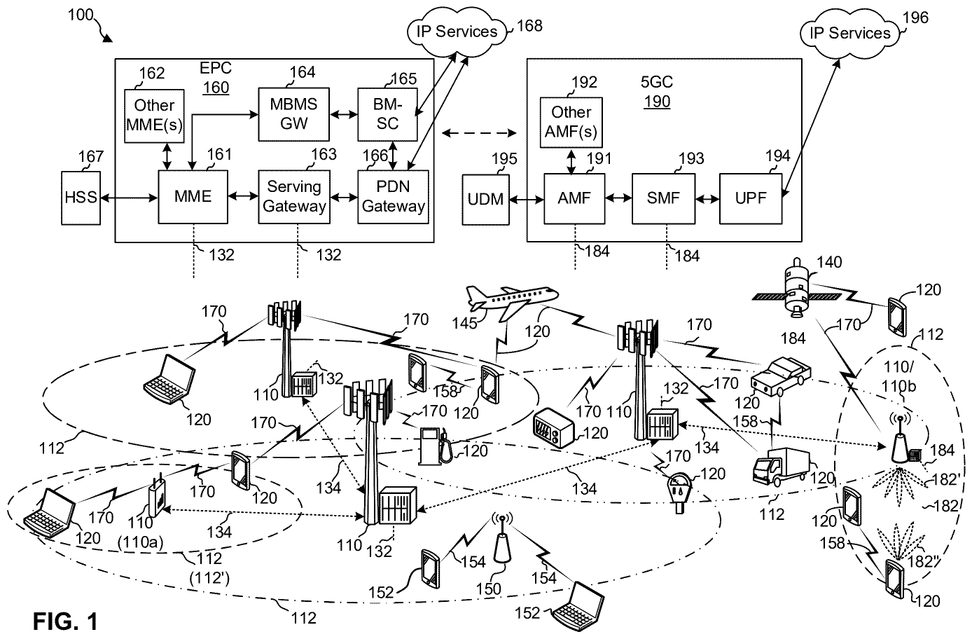

FIG. 1 depicts an example of a wireless communications network 100, in accordance with the present disclosure.

Generally, wireless communications network 100 includes various network entities (alternatively, network elements or network nodes). A network entity is generally a communications device and/or a communications function performed by a communications device (e.g., a user equipment (UE), a base station (BS), a component of a BS, a server, etc.). For example, various functions of a network as well as various devices associated with and interacting with a network may be considered network entities. Further, wireless communications network 100 includes terrestrial aspects, such as ground-based network entities (e.g., BSs 110), and non-terrestrial aspects, such as satellite 140 and aircraft 145, which may include network entities on-board (e.g., one or more BSs) capable of communicating with other network elements (e.g., terrestrial BSs) and UEs.

In the depicted example, wireless communications network 100 includes BSs 110, UEs 120, and one or more core networks, such as an Evolved Packet Core (EPC) 160 and 5G Core (5GC) 190, which interoperate to provide communications services over various communications links, including wired and wireless links.

FIG. 1 depicts various example UEs 120, which may include a cellular phone, a smart phone, a session initiation protocol (SIP) phone, a laptop, a personal digital assistant (PDA), a satellite radio, a global positioning system (GPS), a multimedia device, a video device, a digital audio player, a camera, a game console, a tablet, a smart device, a wearable device, a vehicle, an electric meter, a gas pump, a kitchen appliance, a healthcare device, an implant, a sensor/actuator, a display, an internet of things (IOT) device, an always on (AON) device, an edge processing device, or another similar device. A UE 120 may also be referred to as a mobile device, a wireless device, a wireless communication device, a station, a mobile station, a subscriber station, a mobile subscriber station, a mobile unit, a subscriber unit, a wireless unit, a remote unit, a remote device, an access terminal, a mobile terminal, a wireless terminal, a remote terminal, or a handset, among other examples.

BSs 110 may wirelessly communicate with (e.g., transmit signals to or receive signals from) UEs 120 via communications links 170. The communications links 170 between BSs 110 and UEs 120 may carry uplink (UL) (also referred to as reverse link) transmissions from a UE 120 to a BS 110 and/or downlink (DL) (also referred to as forward link) transmissions from a BS 110 to a UE 120. The communications links 170 may use multiple-input and multiple-output (MIMO) antenna technology, including spatial multiplexing, beamforming, and/or transmit diversity in various aspects.

A BS 110 may include, for example, a NodeB, an enhanced NodeB (eNB), a next generation enhanced NodeB (ng-eNB), a next generation NodeB (gNB or gNodeB), an access point, a base transceiver station, a radio base station, a radio transceiver, a transceiver function, a transmission reception point, and/or others. A BS 110 may provide communications coverage for a respective geographic coverage area 112, which may sometimes be referred to as a cell, and which may overlap in some cases (e.g., a small cell provided by a BS 110a may have a coverage area 112′ that overlaps the coverage area 112 of a macro cell). A BS 110 may, for example, provide communications coverage for a macro cell (covering a relatively large geographic area), a pico cell (covering a relatively smaller geographic area, such as a sports stadium), a femto cell (covering a relatively smaller geographic area (e.g., a home)), and/or other types of cells.

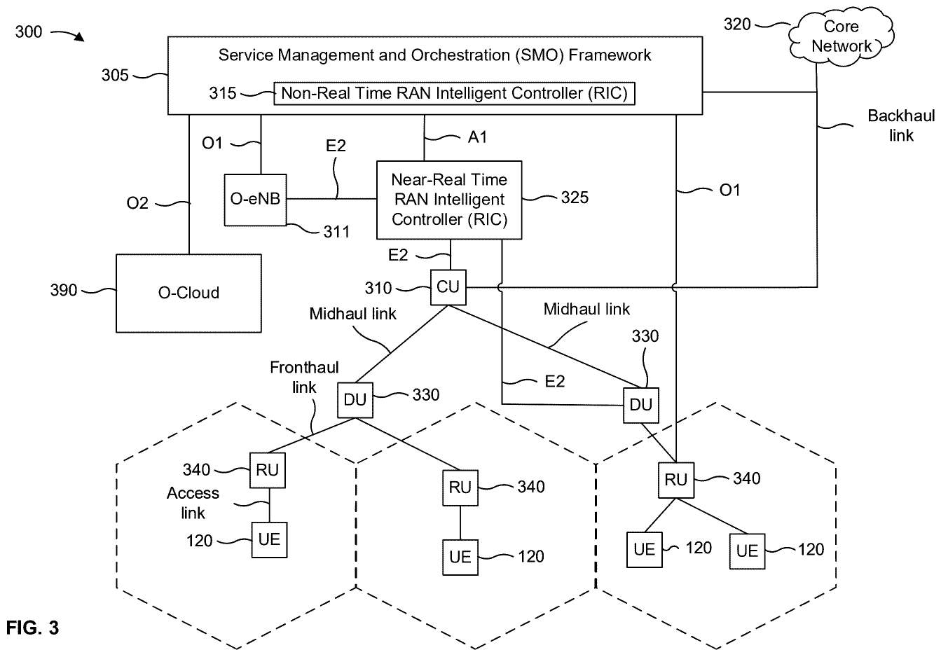

While BSs 110 are depicted in various aspects as unitary communications devices, BSs 110 may be implemented in various configurations. For example, one or more components of a base station may be disaggregated, including a central unit (CU), one or more distributed units (DUs), one or more radio units (RUs), a Near-Real Time (Near-RT) radio access network (RAN) Intelligent Controller (RIC), or a Non-Real Time (Non-RT) RIC, to name a few examples. In another example, various aspects of a base station may be virtualized. More generally, a BS (e.g., BS 110) may include components that are located at a single physical location or components located at various physical locations. In examples in which a BS includes components that are located at various physical locations, the various components may each perform functions such that, collectively, the various components achieve functionality that is similar to a BS that is located at a single physical location. In some aspects, a BS including components that are located at various physical locations may be referred to as having a disaggregated RAN architecture, such as an Open RAN (O-RAN) architecture or a Virtualized RAN (vRAN) architecture. FIG. 3 depicts and describes an example disaggregated BS architecture.

Different BSs 110 within wireless communications network 100 may also be configured to support different radio access technologies, such as 3G, 4G, and/or 5G, among other examples. For example, BSs 110 configured for 4G LTE (collectively referred to as Evolved Universal Mobile Telecommunications System (UMTS) Terrestrial Radio Access Network (E-UTRAN)) may interface with the EPC 160 through first backhaul links 132 (e.g., an S1 interface). BSs 110 configured for 5G (e.g., 5G NR or Next Generation RAN (NG-RAN)) may interface with 5GC 190 through second backhaul links 184. BSs 110 may communicate directly or indirectly (e.g., through the EPC 160 or 5GC 190) with each other over third backhaul links 134 (e.g., X2 interfaces), which may be wired or wireless.

Wireless communications network 100 may subdivide the electromagnetic spectrum into various classes, bands, channels, or other features. In some aspects, the subdivision is based on wavelength and frequency, where frequency may also be referred to as a carrier, a subcarrier, a frequency channel, a tone, or a subband. For example, the 3rd Generation Partnership Project (3GPP) currently defines Frequency Range 1 (FR1) as including 410 MHz-7125 MHz, which is often referred to (interchangeably) as “Sub-6 GHz”. Similarly, 3GPP currently defines Frequency Range 2 (FR2) as including 24,250 MHz-52,600 MHz, which is sometimes referred to (interchangeably) as a “millimeter wave” (“mmW” or “mm Wave”). A base station configured to communicate using mm Wave or near mm Wave radio frequency bands (e.g., a mm Wave base station such as BS 110b) may utilize beamforming (e.g., as shown by 182) with a UE (e.g., 120) to improve path loss and range.

The communications links 170 between BSs 110 and, for example, UEs 120, may be through one or more carriers, which may have different bandwidths (e.g., 5 MHz, 10 MHz, 15 MHz, 20 MHz, 100 MHz, 400 MHz, and/or other bandwidths), and which may be aggregated in various aspects. Carriers may or may not be adjacent to each other. In some examples, allocation of carriers may be asymmetric with respect to DL and UL (e.g., more or fewer carriers may be allocated for DL than for UL).

Communications using higher frequency bands may have higher path loss and a shorter range compared to lower frequency communications. Accordingly, certain base stations (e.g., base station 110b in FIG. 1) may utilize beamforming with a UE 120 to improve path loss and range, as shown at 182. For example, BS 110b and the UE 120 may each include a plurality of antennas, such as antenna elements, antenna panels, and/or antenna arrays to facilitate the beamforming. In some cases, BS 110b may transmit a beamformed signal to UE 120 in one or more transmit directions 182′. UE 120 may receive the beamformed signal from the BS 110b in one or more receive directions 182″. UE 120 may also transmit a beamformed signal to the BS 110b in one or more transmit directions 182″. BS 110b may also receive the beamformed signal from UE 120 in one or more receive directions 182′. BS 110b and UE 120 may then perform beam training to determine the best receive and transmit directions for each of BS 110b and UE 120. Notably, the transmit and receive directions for BS 110b may or may not be the same. Similarly, the transmit and receive directions for UE 120 may or may not be the same.

Wireless communications network 100 further includes a Wi-Fi access point (AP) 150 in communication with Wi-Fi stations (STAs) 152 via communications links 154 in, for example, a 2.4 GHz and/or 5 GHz unlicensed frequency spectrum.

Certain UEs 120 may communicate with each other using device-to-device (D2D) communications link 158. D2D communications link 158 may use one or more sidelink channels, such as a physical sidelink broadcast channel (PSBCH), a physical sidelink discovery channel (PSDCH), a physical sidelink shared channel (PSSCH), a physical sidelink control channel (PSCCH), and/or a physical sidelink feedback channel (PSFCH).

EPC 160 may include various functional components, including: a Mobility Management Entity (MME) 161, other MMEs 162, a Serving Gateway 163, a Multimedia Broadcast Multicast Service (MBMS) Gateway 164, a Broadcast Multicast Service Center (BM-SC) 165, and/or a Packet Data Network (PDN) Gateway 166, such as in the depicted example. MME 161 may be in communication with a Home Subscriber Server (HSS) 167. MME 161 is a control node that processes the signaling between the UEs 120 and the EPC 160. Generally, MME 161 provides bearer and connection management.

Generally, user Internet protocol (IP) packets are transferred through Serving Gateway 163, which is connected to PDN Gateway 166. PDN Gateway 166 provides UE IP address allocation as well as other functions. PDN Gateway 166 and the BM-SC 165 are connected to IP Services 168, which may include, for example, the Internet, an intranet, an IP Multimedia Subsystem (IMS), a Packet Switched (PS) streaming service, and/or other IP services.

BM-SC 165 may provide functions for MBMS user service provisioning and delivery. BM-SC 165 may serve as an entry point for content provider MBMS transmission, may be used to authorize and initiate MBMS Bearer Services within a public land mobile network (PLMN), and/or may be used to schedule MBMS transmissions. MBMS Gateway 164 may distribute MBMS traffic to the BSs 110 belonging to a Multicast Broadcast Single Frequency Network (MBSFN) area broadcasting a particular service, and/or may be responsible for session management (start/stop) and for collecting eMBMS related charging information.

5GC 190 may include various functional components, including: an Access and Mobility Management Function (AMF) 191, other AMFs 192, a Session Management Function (SMF) 193, and a User Plane Function (UPF) 194. AMF 191 may be in communication with Unified Data Management (UDM) 195.

AMF 191 is a control node that processes signaling between UEs 120 and 5GC 190. AMF 191 provides, for example, quality of service (QoS) flow and session management.

IP packets are transferred through UPF 194, which is connected to the IP Services 196, and which provides UE IP address allocation as well as other functions for 5GC 190. IP Services 196 may include, for example, the Internet, an intranet, an IMS, a PS streaming service, and/or other IP services.

In various aspects, a network entity or network node can be implemented as an aggregated base station, a disaggregated base station, a component of a base station, an integrated access and backhaul (IAB) node, a relay node, a sidelink node, a transmission reception point (TRP), or a combination thereof, to name a few examples.

As indicated above, FIG. 1 is provided as an example. Other examples may differ from what is described with regard to FIG. 1.

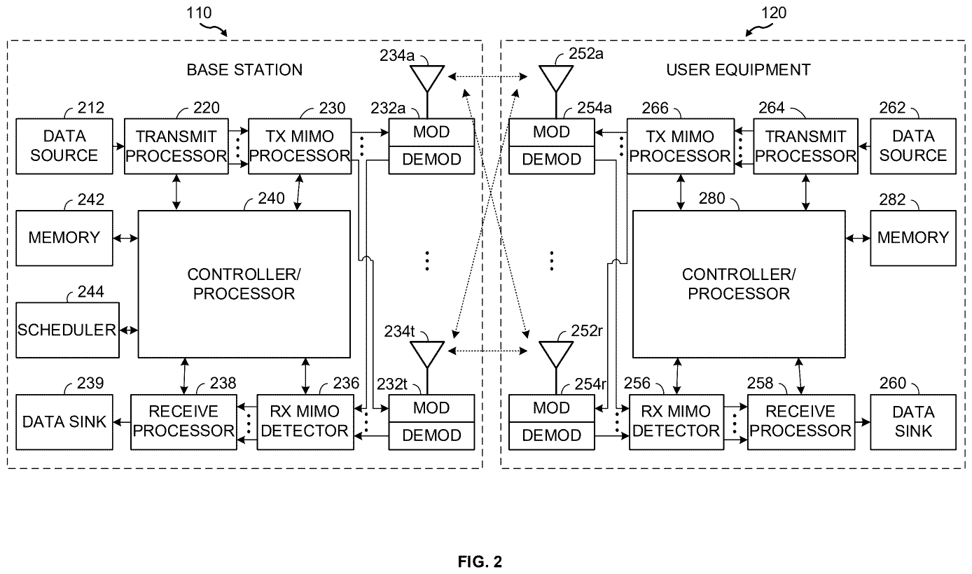

FIG. 2 depicts aspects of an example BS 110 and UE 120, in accordance with the present disclosure.

Generally, BS 110 includes various processors (e.g., 220, 230, 238, and 240), antennas 234a-t (collectively 234), transceivers 232a-t (collectively 232), which include modulators and demodulators, and other aspects, which enable wireless transmission of data (e.g., data source 212) and wireless reception of data (e.g., data sink 239). For example, BS 110 may send and receive data between BS 110 and UE 120. BS 110 includes controller/processor 240, which may be configured to implement various functions described herein related to wireless communications.

Generally, UE 120 includes various processors (e.g., 258, 264, 266, and 280), antennas 252a-r (collectively 252), transceivers 254a-r (collectively 254), which include modulators and demodulators, and other aspects, which enable wireless transmission of data (e.g., retrieved from data source 262) and wireless reception of data (e.g., provided to data sink 260). UE 120 includes controller/processor 280, which may be configured to implement various functions described herein related to wireless communications.

For an example downlink transmission, BS 110 includes a transmit processor 220 that may receive data from a data source 212 and control information from a controller/processor 240. The control information may be for the physical broadcast channel (PBCH), the physical control format indicator channel (PCFICH), the physical hybrid automatic repeat request (HARQ) indicator channel (PHICH), the physical downlink control channel (PDCCH), the group common PDCCH (GC PDCCH), and/or other channels. The data may be for the physical downlink shared channel (PDSCH), in some examples.

Transmit processor 220 may process (e.g., encode and symbol map) the data and control information to obtain data symbols and control symbols, respectively. Transmit processor 220 may also generate reference symbols, such as for the primary synchronization signal (PSS), the secondary synchronization signal (SSS), the PBCH demodulation reference signal (DMRS), or the channel state information reference signal (CSI-RS).

Transmit (TX) MIMO processor 230 may perform spatial processing (e.g., precoding) on the data symbols, the control symbols, and/or the reference symbols, if applicable, and may provide output symbol streams to the modulators (MODs) in transceivers 232a-232t. Each modulator in transceivers 232a-232t may process a respective output symbol stream to obtain an output sample stream. Each modulator may further process (e.g., convert to analog, amplify, filter, and upconvert) the output sample stream to obtain a downlink signal. Downlink signals from the modulators in transceivers 232a-232t may be transmitted via the antennas 234a-234t, respectively.

UE 120 includes antennas 252a-252r that may receive the downlink signals from the BS 110 and may provide received signals to the demodulators (DEMODs) in transceivers 254a-254r, respectively. Each demodulator in transceivers 254a-254r may condition (e.g., filter, amplify, downconvert, and digitize) a respective received signal to obtain input samples. Each demodulator may further process the input samples to obtain received symbols.

Receive (RX) MIMO detector 256 may obtain received symbols from all the demodulators in transceivers 254a-254r, perform MIMO detection on the received symbols if applicable, and provide detected symbols. Receive processor 258 may process (e.g., demodulate, deinterleave, and decode) the detected symbols, provide decoded data for the UE 120 to a data sink 260, and provide decoded control information to a controller/processor 280.

For an example uplink transmission, UE 120 further includes a transmit processor 264 that may receive and process data (e.g., for the physical uplink shared channel (PUSCH)) from a data source 262 and control information (e.g., for the physical uplink control channel (PUCCH)) from the controller/processor 280. Transmit processor 264 may also generate reference symbols for a reference signal (e.g., for the sounding reference signal (SRS)). The symbols from the transmit processor 264 may be precoded by a TX MIMO processor 266 if applicable, further processed by the modulators in transceivers 254a-254r (e.g., for SC-FDM), and transmitted to BS 110.

At BS 110, the uplink signals from UE 120 may be received by antennas 234a-234t, processed by the demodulators in transceivers 232a-232t, detected by a MIMO detector 236 if applicable, and further processed by a receive processor 238 to obtain decoded data and control information sent by UE 120. Receive processor 238 may provide the decoded data to a data sink 239 and the decoded control information to the controller/processor 240. Memories 242 and 282 may store data and program codes (e.g., processor-executable instructions, computer-executable instructions) for BS 110 and UE 120, respectively. Scheduler 244 may schedule UEs for data transmission on the downlink and/or uplink.

In various aspects, BS 110 may be described as transmitting and receiving various types of data associated with the methods described herein. In these contexts, “transmitting” may refer to various mechanisms of outputting data, such as outputting data from data source 212, scheduler 244, memory 242, transmit processor 220, controller/processor 240, TX MIMO processor 230, transceivers 232a-t, antenna 234a-t, and/or other aspects described herein. Similarly, “receiving” may refer to various mechanisms of obtaining data, such as obtaining data from antennas 234a-t, transceivers 232a-t, RX MIMO detector 236, controller/processor 240, receive processor 238, scheduler 244, memory 242, a network interface, and/or other aspects described herein.

In various aspects, UE 120 may likewise be described as transmitting and receiving various types of data associated with the methods described herein. In these contexts, “transmitting” may refer to various mechanisms of outputting data, such as outputting data from data source 262, memory 282, transmit processor 264, controller/processor 280, TX MIMO processor 266, transceivers 254a-t, antenna 252a-t, and/or other aspects described herein. Similarly, “receiving” may refer to various mechanisms of obtaining data, such as obtaining data from antennas 252a-t, transceivers 254a-t, RX MIMO detector 256, controller/processor 280, receive processor 258, memory 282, and/or other aspects described herein.

In some aspects, a processor may be configured to perform various operations, such as those associated with the methods described herein, and transmit (output) data to or receive (obtain) data from another interface that is configured to transmit or receive, respectively, the data.

While blocks in FIG. 2 are illustrated as distinct components, the functions described above with respect to the blocks may be implemented in a single hardware, software, or combination component or in various combinations of components. For example, the functions described with respect to the transmit processor 264, the receive processor 258, and/or the TX MIMO processor 266 may be performed by or under the control of the controller/processor 280.

As indicated above, FIG. 2 is provided as an example. Other examples may differ from what is described with regard to FIG. 2.

Deployment of communication systems, such as 5G NR systems, may be arranged in multiple manners with various components or constituent parts. In a 5G NR system, or network, a network node, a network entity, a mobility element of a network, a RAN node, a core network node, a network element, a base station, or a network equipment may be implemented in an aggregated or disaggregated architecture. For example, a base station (such as a Node B (NB), an evolved NB (eNB), an NR BS, a 5G NB, an AP, a TRP, or a cell, among other examples), or one or more units (or one or more components) performing base station functionality, may be implemented as an aggregated base station (also known as a standalone base station or a monolithic base station) or a disaggregated base station. “Network entity” or “network node” may refer to a disaggregated base station, or to one or more units of a disaggregated base station (such as one or more CUs, one or more DUs, one or more RUs, or a combination thereof).

An aggregated base station (e.g., an aggregated network node) may be configured to utilize a radio protocol stack that is physically or logically integrated within a single RAN node (e.g., within a single device or unit). A disaggregated base station (e.g., a disaggregated network node) may be configured to utilize a protocol stack that is physically or logically distributed among two or more units (such as one or more CUs, one or more DUs, or one or more RUs). In some examples, a CU may be implemented within a network node, and one or more DUs may be co-located with the CU, or alternatively, may be geographically or virtually distributed throughout one or multiple other network nodes. The DUs may be implemented to communicate with one or more RUs. Each of the CU, DU and RU also can be implemented as virtual units, such as a virtual central unit (VCU), a virtual distributed unit (VDU), or a virtual radio unit (VRU), among other examples.

Base station-type operation or network design may consider aggregation characteristics of base station functionality. For example, disaggregated base stations may be utilized in an IAB network, an O-RAN (such as the network configuration sponsored by the O-RAN Alliance), or a vRAN (also known as a cloud radio access network (C-RAN)) to facilitate scaling of communication systems by separating base station functionality into one or more units that can be individually deployed. A disaggregated base station may include functionality implemented across two or more units at various physical locations, as well as functionality implemented for at least one unit virtually, which can enable flexibility in network design. The various units of the disaggregated base station can be configured for wired or wireless communication with at least one other unit of the disaggregated base station.

FIG. 3 depicts an example disaggregated base station 300 architecture, in accordance with the present disclosure. The disaggregated base station 300 architecture may include one or more CUs 310 that can communicate directly with a core network 320 via a backhaul link, or indirectly with the core network 320 through one or more disaggregated base station units (such as a Near-RT RIC 325 via an E2 link, or a Non-RT RIC 315 associated with a Service Management and Orchestration (SMO) Framework 305, or both). A CU 310 may communicate with one or more DUs 330 via respective midhaul links, such as an F1 interface. The DUs 330 may communicate with one or more RUs 340 via respective fronthaul links. The RUs 340 may communicate with respective UEs 120 via one or more radio frequency (RF) access links. In some implementations, the UE 120 may be simultaneously served by multiple RUs 340.

Each of the units (e.g., the CUS 310, the DUs 330, the RUs 340, as well as the Near-RT RICs 325, the Non-RT RICs 315 and the SMO Framework 305) may include one or more interfaces or be coupled to one or more interfaces configured to receive or transmit signals, data, or information (collectively, signals) via a wired or wireless transmission medium. Each of the units, or an associated processor or controller providing instructions to the communications interfaces of the units, can be configured to communicate with one or more of the other units via the transmission medium. For example, the units can include a wired interface configured to receive or transmit signals over a wired transmission medium to one or more of the other units. Additionally or alternatively, the units can include a wireless interface, which may include a receiver, a transmitter or transceiver (such as an RF transceiver), configured to receive or transmit signals, or both, over a wireless transmission medium to one or more of the other units.

In some aspects, the CU 310 may host one or more higher layer control functions. Such control functions can include RRC, packet data convergence protocol (PDCP), service data adaptation protocol (SDAP), or the like. Each control function can be implemented with an interface configured to communicate signals with other control functions hosted by the CU 310. The CU 310 may be configured to handle user plane functionality (e.g., Central Unit-User Plane (CU-UP)), control plane functionality (e.g., Central Unit-Control Plane (CU-CP)), or a combination thereof. In some implementations, the CU 310 can be logically split into one or more CU-UP units and one or more CU-CP units. The CU-UP unit can communicate bidirectionally with the CU-CP unit via an interface, such as the E1 interface when implemented in an O-RAN configuration. The CU 310 can be implemented to communicate with the DU 330, as necessary, for network control and signaling.

The DU 330 may correspond to a logical unit that includes one or more base station functions to control the operation of one or more RUs 340. In some aspects, the DU 330 may host one or more of a radio link control (RLC) layer, a medium access control (MAC) layer, and one or more high physical (PHY) layers (such as modules for forward error correction (FEC) encoding and decoding, scrambling, modulation and demodulation, or the like) depending, at least in part, on a functional split, such as those defined by 3GPP. In some aspects, the DU 330 may further host one or more low PHY layers. Each layer (or module) can be implemented with an interface configured to communicate signals with other layers (and modules) hosted by the DU 330, or with the control functions hosted by the CU 310.

Lower-layer functionality can be implemented by one or more RUs 340. In some deployments, an RU 340, controlled by a DU 330, may correspond to a logical node that hosts RF processing functions, or low-PHY layer functions (such as performing fast Fourier transform (FFT), inverse FFT (iFFT), digital beamforming, physical random access channel (PRACH) extraction and filtering, or the like), or both, based at least in part on the functional split, such as a lower layer functional split. In such an architecture, the RU(s) 340 can be implemented to handle over-the-air (OTA) communications with one or more UEs 120. In some implementations, real-time and non-real-time aspects of control and user plane communications with the RU(s) 340 can be controlled by the corresponding DU 330. In some scenarios, this configuration can enable the DU(s) 330 and the CU 310 to be implemented in a cloud-based RAN architecture, such as a vRAN architecture.

The SMO Framework 305 may be configured to support RAN deployment and provisioning of non-virtualized and virtualized network elements. For non-virtualized network elements, the SMO Framework 305 may be configured to support the deployment of dedicated physical resources for RAN coverage requirements which may be managed via an operations and maintenance interface (such as an O1 interface). For virtualized network elements, the SMO Framework 305 may be configured to interact with a cloud computing platform (such as an open cloud (O-Cloud) 390) to perform network element life cycle management (such as to instantiate virtualized network elements) via a cloud computing platform interface (such as an O2 interface). Such virtualized network elements can include, but are not limited to, CUs 310, DUs 330, RUs 340, and Near-RT RICs 325. In some implementations, the SMO Framework 305 can communicate with a hardware aspect of a 4G RAN, such as an open eNB (O-eNB) 311, via an O1 interface. Additionally, in some implementations, the SMO Framework 305 can communicate directly with one or more RUs 340 via an O1 interface. The SMO Framework 305 also may include a Non-RT RIC 315 configured to support functionality of the SMO Framework 305.

The Non-RT RIC 315 may be configured to include a logical function that enables non-real-time control and optimization of RAN elements and resources, artificial intelligence/machine learning (AI/ML) workflows including model training and updates, or policy-based guidance of applications/features in the Near-RT RIC 325. The Non-RT RIC 315 may be coupled to or communicate with (such as via an A1 interface) the Near-RT RIC 325. The Near-RT RIC 325 may be configured to include a logical function that enables near-real-time control and optimization of RAN elements and resources via data collection and actions over an interface (such as via an E2 interface) connecting one or more CUs 310, one or more DUs 330, or both, as well as an O-eNB, with the Near-RT RIC 325.

In some implementations, to generate AI/ML models to be deployed in the Near-RT RIC 325, the Non-RT RIC 315 may receive parameters or external enrichment information from external servers. Such information may be utilized by the Near-RT RIC 325 and may be received at the SMO Framework 305 or the Non-RT RIC 315 from non-network data sources or from network functions. In some examples, the Non-RT RIC 315 or the Near-RT RIC 325 may be configured to tune RAN behavior or performance. For example, the Non-RT RIC 315 may monitor long-term trends and patterns for performance and employ AI/ML models to perform corrective actions through the SMO Framework 305 (such as reconfiguration via O1) or via creation of RAN management policies (such as A1 policies).

As indicated above, FIG. 3 is provided as an example. Other examples may differ from what is described with regard to FIG. 3.

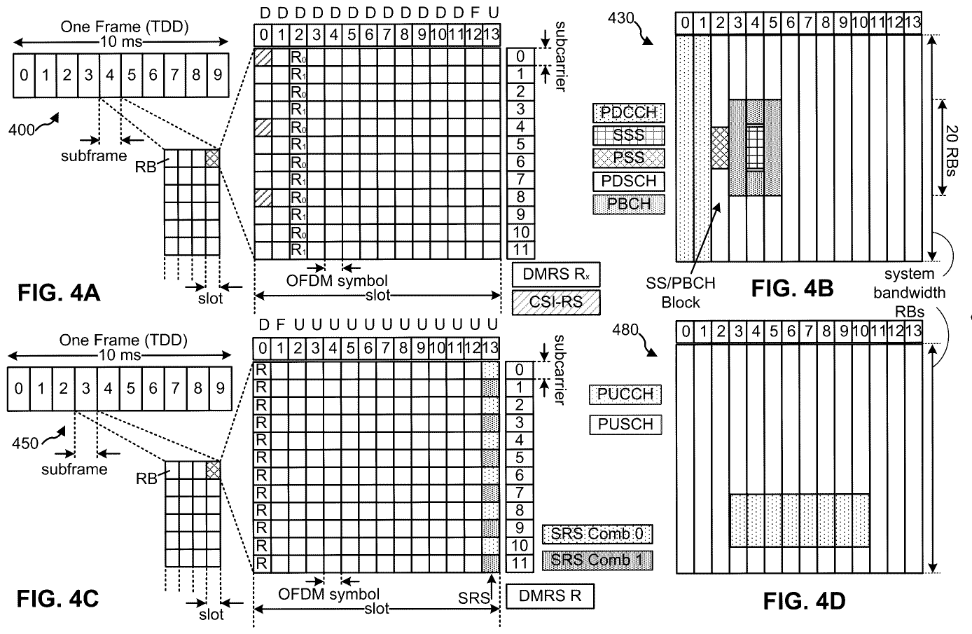

FIGS. 4A, 4B, 4C, and 4D depict aspects of data structures for a wireless communications network, such as wireless communications network 100 of FIG. 1, in accordance with the present disclosure. FIG. 4A is a diagram 400 illustrating an example of a first subframe within a 5G (e.g., 5G NR) frame structure, FIG. 4B is a diagram 430 illustrating an example of DL channels within a 5G subframe, FIG. 4C is a diagram 450 illustrating an example of a second subframe within a 5G frame structure, and FIG. 4D is a diagram 480 illustrating an example of UL channels within a 5G subframe.

Wireless communications systems may utilize orthogonal frequency division multiplexing (OFDM) with a cyclic prefix (CP) on the uplink and downlink. Such systems may also support half-duplex operation using time division duplexing. OFDM and single-carrier frequency division multiplexing (SC-FDM) partition the system bandwidth (e.g., as depicted in FIGS. 4B and 4D) into multiple orthogonal subcarriers. Each subcarrier may be modulated with data. Modulation symbols may be sent in the frequency domain with OFDM and/or in the time domain with SC-FDM.

A wireless communications frame structure may be frequency division duplex (FDD), in which, for a particular set of subcarriers, subframes within the set of subcarriers are dedicated for either DL or UL. Wireless communications frame structures may also be time division duplex (TDD), in which, for a particular set of subcarriers, subframes within the set of subcarriers are dedicated for both DL and UL.

In FIGS. 4A and 4C, the wireless communications frame structure is TDD where D is DL, U is UL, and F is flexible for use between DL/UL. UEs may be configured with a slot format through a received slot format indicator (SFI) (dynamically through DL control information (DCI), or semi-statically/statically through RRC signaling). In the depicted examples, a 10 ms frame is divided into 10 equally sized 1 ms subframes. Each subframe may include one or more time slots. In some examples, each slot may include 7 or 14 symbols, depending on the slot format. Subframes may also include mini-slots, which generally have fewer symbols than an entire slot. Other wireless communications technologies may have a different frame structure and/or different channels.

In certain aspects, the number of slots within a subframe is based on a slot configuration and a numerology. For example, for slot configuration 0, different numerologies (μ) 0 to 5 allow for 1, 2, 4, 8, 16, and 32 slots, respectively, per subframe. For slot configuration 1, different numerologies 0 to 2 allow for 2, 4, and 8 slots, respectively, per subframe. Accordingly, for slot configuration 0 and numerology μ, there are 14 symbols/slot and 2_{μ} slots/subframe. The subcarrier spacing and symbol length/duration are a function of the numerology. The subcarrier spacing may be equal to 2^{μ}×15 kHz, where u is the numerology index, which may be selected from values 0 to 5. Accordingly, the numerology μ=0 has a subcarrier spacing of 15 kHz and the numerology μ=5 has a subcarrier spacing of 480 kHz. Other numerologies and subcarrier spacings may be used. The symbol length/duration is inversely related to the subcarrier spacing. FIGS. 4A, 4B, 4C, and 4D provide an example of slot configuration 0 with 14 symbols per slot and numerology μ=2 with 4 slots per subframe. The slot duration is 0.25 ms, the subcarrier spacing is 60 kHz, and the symbol duration is approximately 16.67 μs.

As depicted in FIGS. 4A, 4B, 4C, and 4D, a resource grid may be used to represent the frame structure. Each time slot includes a resource block (RB) (also referred to as physical RBs (PRBs)) that extends, for example, 12 consecutive subcarriers. The resource grid is divided into multiple resource elements (REs). The number of bits carried by each RE depends on the modulation scheme.

As illustrated in FIG. 4A, some of the REs carry reference (pilot) signals (RSS) for a UE (e.g., UE 120). The RSs may include DMRSs and/or CSI-RSs for channel estimation at the UE. The RSs may also include beam measurement RSs (BRSs), beam refinement RSs (BRRSs), and/or phase tracking RSs (PT-RSs).

FIG. 4B illustrates an example of various DL channels within a subframe of a frame. The PDCCH carries DCI within one or more control channel elements (CCEs), each CCE including, for example, nine RE groups (REGs), each REG including, for example, four consecutive REs in an OFDM symbol.

A PSS may be within symbol 2 of particular subframes of a frame. The PSS is used by a UE (e.g., UE 120) to determine subframe/symbol timing and a physical layer identity.

An SSS may be within symbol 4 of particular subframes of a frame. The SSS is used by a UE to determine a physical layer cell identity group number and radio frame timing.

Based on the physical layer identity and the physical layer cell identity group number, the UE can determine a physical cell identifier (PCI). Based on the PCI, the UE can determine the locations of the aforementioned DMRSs. The PBCH, which carries a master information block (MIB), may be logically grouped with the PSS and SSS to form a synchronization signal (SS)/PBCH block (also referred to as an SS block (SSB)). The MIB provides a number of RBs in the system bandwidth and a system frame number (SFN). The PDSCH carries user data, broadcast system information not transmitted through the PBCH such as system information blocks (SIBs), and/or paging messages.

As illustrated in FIG. 4C, some of the REs carry DMRSs (indicated as R for one particular configuration, but other DMRS configurations are possible) for channel estimation at the base station. The UE may transmit DMRSs for the PUCCH and DMRSs for the PUSCH. The PUSCH DMRSs may be transmitted, for example, in the first one or two symbols of the PUSCH. The PUCCH DMRSs may be transmitted in different configurations depending on whether short or long PUCCHs are transmitted and depending on the particular PUCCH format used. UE 120 may transmit SRSs. The SRSs may be transmitted, for example, in the last symbol of a subframe. The SRSs may have a comb structure, and a UE may transmit SRSs on one of the combs. The SRSs may be used by a base station for channel quality estimation to enable frequency-dependent scheduling on the UL.

FIG. 4D illustrates an example of various UL channels within a subframe of a frame. The PUCCH may be located as indicated in one configuration. The PUCCH carries uplink control information (UCI), such as scheduling requests, a channel quality indicator (CQI), a precoding matrix indicator (PMI), a rank indicator (RI), and HARQ ACK/NACK feedback. The PUSCH carries data, and may additionally be used to carry a BSR, a power headroom report (PHR), and/or UCI.

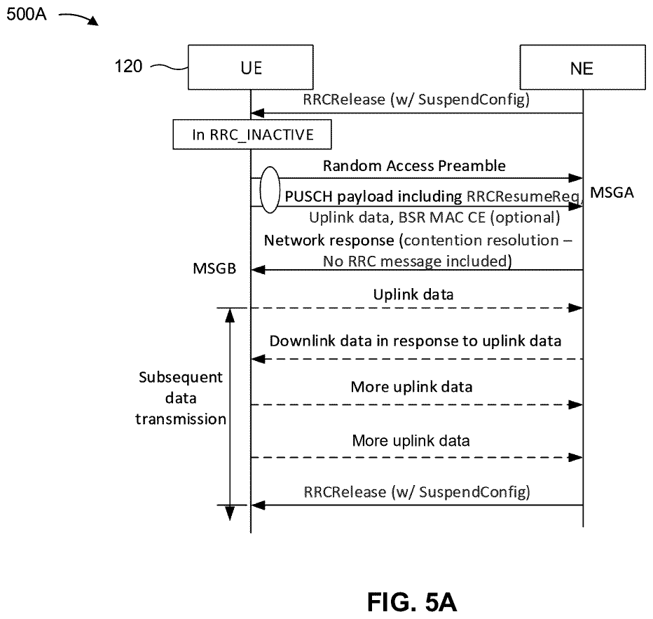

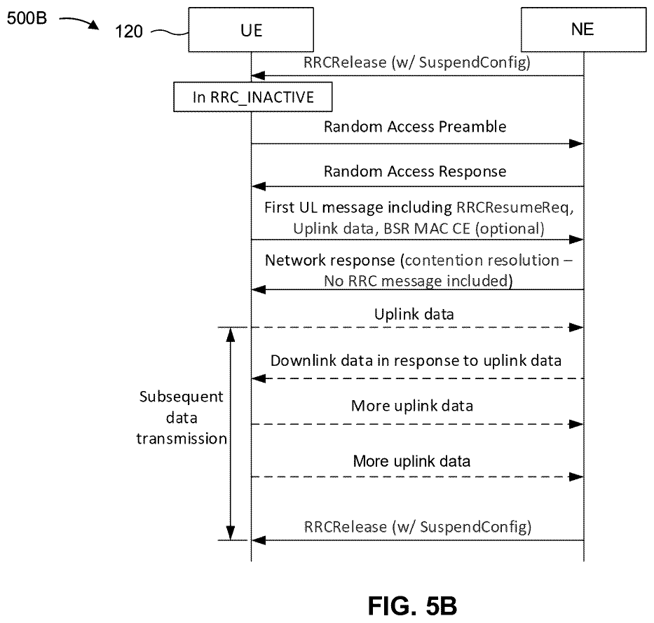

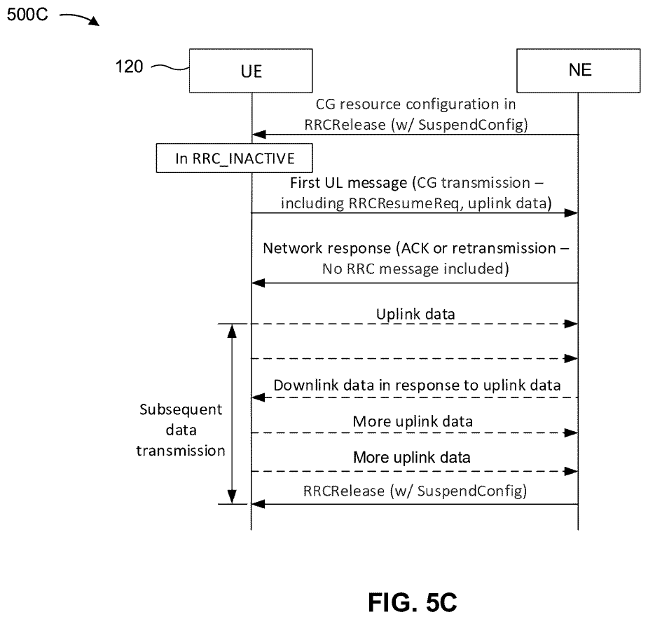

FIGS. 5A-5C are diagrams illustrating examples 500A-500C of MO-SDT procedures, in accordance with the present disclosure. As shown in FIGS. 5A-5C, examples 500A-500C include communication between a network entity (e.g., a base station 110 or one or more components of a disaggregated base station as illustrated in FIG. 3) and a UE 120. In some aspects, the network entity and the UE 120 may be included in a wireless network, such as wireless communication network 100. The network entity and the UE 120 may communicate via a wireless access link, which may include an uplink and a downlink.

As described herein, the network entity and the UE 120 may communicate in a wireless network that supports one or more MO-SDT procedures, which generally allow the UE 120 to transmit mobile-originated uplink small data (e.g., an uplink transmission having a payload size that is less than or equal to a threshold and/or subsequent uplink control information) while the UE 120 is in an RRC inactive or an RRC idle state without the UE 120 having to transition to an RRC connected state. In general, as described herein, the uplink small data may originate from a control plane or a data plane. For example, when the UE 120 switches from the RRC connected state to the RRC inactive or RRC idle state, the UE 120 may resume a DRB to transmit uplink small data that originates from the data plane. Additionally, or alternatively, the network entity may configure one or more SRBs to transfer non-access stratum (NAS) messages from the control plane.

For example, example 500A in FIG. 5A depicts a random access (RA)-based SDT procedure that allows the UE 120 to perform an uplink SDT from an RRC inactive or an RRC idle state during a two-step RACH procedure. For example, as shown in FIG. 5A, the network entity may transmit an RRC release message to the UE 120 with a suspend configuration parameter enabled, which may cause the UE 120 to transition to the RRC inactive or idle state. In cases where the UE 120 has uplink data to transmit and the uplink data has a payload size that fails to satisfy (e.g., is less than or equal to a threshold), the UE 120 may initiate a two-step RACH procedure from the RRC inactive or idle state in order to transmit the uplink small data. For example, as shown, the UE 120 may transmit a msgA communication, which includes a random access preamble and a PUSCH payload that includes an RRC resume request and the uplink small data. In some cases, the PUSCH payload may also include a BSR MAC control element (MAC-CE). As further shown, the network entity may then transmit a msgB communication including a network response to the UE 120, where the msgB communication may include a contention resolution message with no RRC message included. For example, the network response may be used to control subsequent transmissions of uplink small data by the UE 120 and/or downlink small data to the UE 120 as well as state transition decisions between any subsequent SDTs. For example, as shown, the network entity may transmit an RRC release message with the suspend configuration parameter enabled to terminate the uplink and/or downlink SDTs.

Additionally, or alternatively, example 500B in FIG. 5B depicts an RA-based SDT procedure that allows the UE 120 to perform an uplink SDT from an RRC inactive or an RRC idle state during a four-step RACH procedure. For example, as shown in FIG. 5B, the network entity may transmit an RRC release message to the UE 120 with a suspend configuration parameter enabled, which may cause the UE 120 to transition to the RRC inactive or idle state. In cases where the UE 120 has uplink data to transmit and the uplink data has a payload size that fails to satisfy (e.g., is less than or equal to a threshold), the UE 120 may initiate a four-step RACH procedure from the RRC inactive or idle state in order to transmit the uplink small data. For example, as shown, the UE 120 may transmit a msg1 communication that includes a random access preamble to the network entity, and the network entity may then transmit a msg2 communication that includes a random access response message to the UE 120. The UE 120 may then transmit a first uplink message in a msg3 communication, where the first uplink message includes an RRC resume request and the uplink small data. As further shown, the network entity may then transmit a msg4 communication including a network response to the UE 120, where the msg4 communication may include a contention resolution message with no RRC message included. For example, the network response may be used to control subsequent transmissions of uplink small data by the UE 120 and/or downlink small data to the UE 120 as well as state transition decisions between any subsequent SDTs. For example, as shown, the network entity may transmit an RRC release message with the suspend configuration parameter enabled to terminate the uplink and/or downlink SDTs.

Additionally, or alternatively, example 500C in FIG. 5C depicts an SDT procedure that allows the UE 120 to use a configured grant (CG) to perform an uplink SDT from an RRC inactive or an RRC idle state, whereby example 500C may be referred to herein as a CG-SDT procedure. For example, as shown in FIG. 5C, the network entity may transmit a CG resource configuration that includes one or more CG resource sets that include preconfigured PUSCH resources that can be used to transmit uplink data without a dynamic uplink grant (e.g., reusing a CG type 1 configuration). As shown, the CG resource configuration may be included in an RRC release message that is transmitted to the UE 120 with a suspend configuration parameter enabled, which may cause the UE 120 to transition to the RRC inactive or idle state. In cases where the UE 120 has uplink data to transmit and the uplink data has a payload size that fails to satisfy (e.g., is less than or equal to a threshold), the UE 120 may use the preconfigured PUSCH resources to transmit a first uplink message, where the first uplink message is a CG transmission that includes an RRC resume request and the uplink small data. As further shown, the network entity may then transmit a network response to the UE 120, where the network response may include an acknowledgement (ACK) or a request for a retransmission with no RRC message included in the network response. For example, the network response may be used to control subsequent transmissions of uplink small data by the UE 120 and/or downlink small data to the UE 120 as well as state transition decisions between any subsequent SDTs. For example, as shown, the network entity may transmit an RRC release message with the suspend configuration parameter enabled to terminate the uplink and/or downlink SDTs.

In general, the CG-SDT procedure depicted in FIG. 5C may differ from the RA-based SDT procedures depicted in FIGS. 5A-5B in terms of whether uplink timing is maintained during the applicable MO-SDT procedure. For example, in the RA-based SDT procedures depicted in FIGS. 5A-5B, the UE 120 may need to first perform a PRACH transmission in which a random access preamble is transmitted to the network entity to establish uplink timing. Alternatively, in the CG-SDT procedure depicted in FIG. 5C, the UE 120 can reuse an uplink timing advance configured in an RRC connected state, and therefore does not need to perform a PRACH transmission before transmitting the uplink small data. Accordingly, the RA-based SDT procedures may provide the UE 120 with flexibility to change locations or otherwise move within a coverage area of the network entity or to the coverage area of a new network entity, which may improve MO-SDT coverage. However, the RA-based SDT procedures require the UE 120 to spend time establish uplink timing, whereby the CG-SDT procedure may offer a lower latency in cases where the network entity receiving the uplink small data is the same network entity that the UE 120 was connected to in the RRC connected state.

As indicated above, FIGS. 5A-5C are provided as examples. Other examples may differ from what is described with regard to FIGS. 5A-5C.

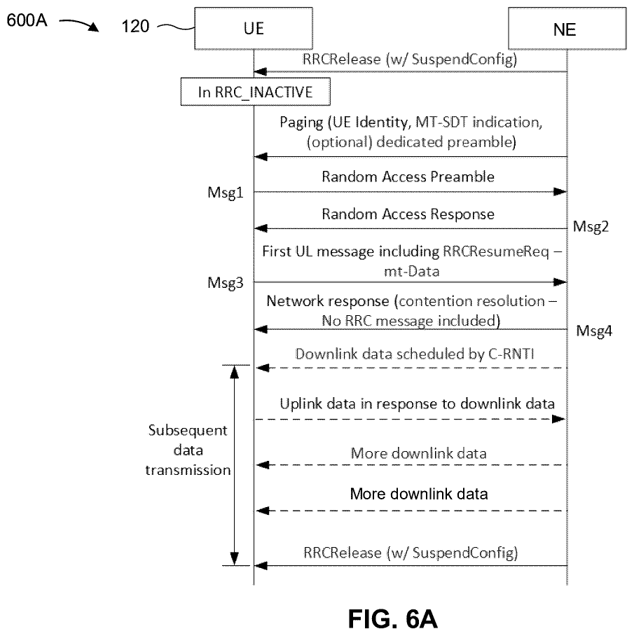

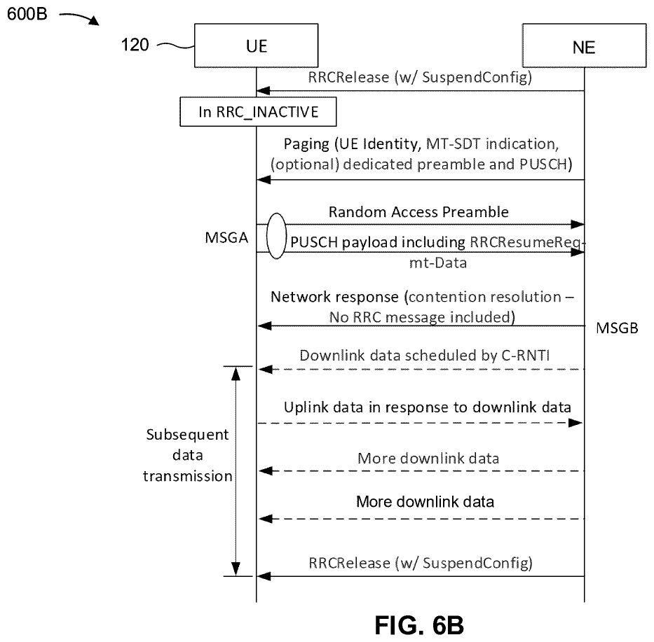

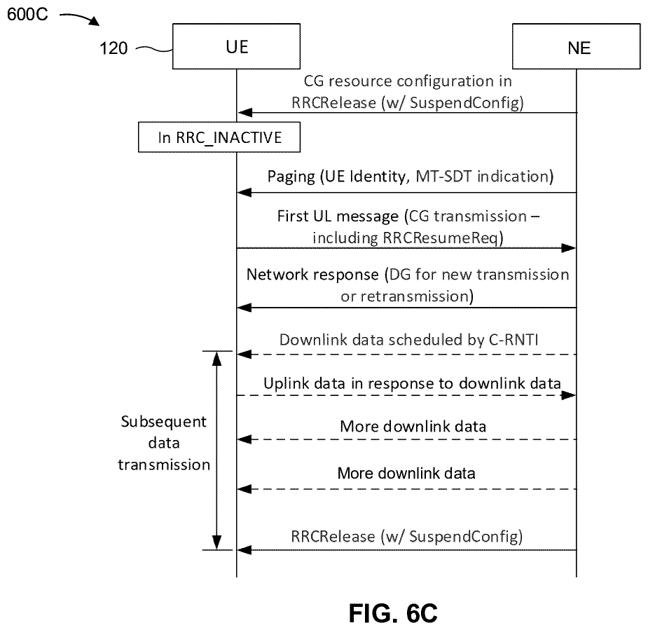

FIGS. 6A-6C are diagrams illustrating examples of mobile-terminated small data transmission (MT-SDT) procedures, in accordance with the present disclosure. As shown in FIGS. 6A-6C, examples 600A-600C include communication between a network entity (e.g., base station 110 or one or more components of a disaggregated base station as illustrated in FIG. 3) and a UE 120. In some aspects, the network entity and the UE 120 may be included in a wireless network, such as wireless communication network 100. The network entity and the UE 120 may communicate via a wireless access link, which may include an uplink and a downlink.

As described herein, the network entity and the UE 120 may communicate in a wireless network that supports one or more MT-SDT procedures, which generally allow the network entity to initiate a mobile-terminated downlink small data transmission to the UE 120 while the UE 120 is in an RRC inactive or an RRC idle state without the UE 120 having to transition to an RRC connected state. In general, as described herein, the MT-SDT procedures may be used for initial downlink data reception at the UE 120 and subsequent uplink and/or downlink small data transmissions while when the UE 120 is in the RRC inactive or RRC idle state. Furthermore, one or more MT-SDT procedures may include a paging-triggered SDT, which may support an MO-SDT procedure (e.g., an RA-SDT procedure and/or a CG-SDT procedure) as an uplink response. For example, as described herein, the network entity may transmit a paging message to the UE 120 to indicate that there is downlink small data targeted to the UE 120, and the UE 120 may then receive the downlink small data from the previous serving network entity or from a different serving network entity within a RAN notification area (RNA) of the UE 120 (e.g., the paging message does not include the downlink small data, but rather indicates to the UE 120 that the downlink small data is available to transmit to the UE 120).

For example, example 600A in FIG. 6A depicts a paging-triggered MT-SDT procedure in which the UE 120 responds to an MT-SDT indication carried in a paging message by initiating a four-step RA procedure (e.g., contention-based random access (CBRA) and/or contention-free random access (CFRA)) or an MO-SDT procedure based on a four-step RA procedure. For example, as shown in FIG. 6A, the network entity may transmit an RRC release message to the UE 120 with a suspend configuration parameter enabled, which may cause the UE 120 to transition to the RRC inactive or idle state. In cases where the network entity has downlink data to transmit to the UE 120 and the downlink data has a payload size that fails to satisfy (e.g., is less than or equal to a threshold), the network entity may transmit a paging message to the UE 120 that includes an identity of the UE and an MT-SDT indication, and optionally further includes a dedicated preamble (e.g., for CFRA). In example 600A, the UE 120 may then transmit a random access preamble in a msg1 communication, and may transmit a first uplink message that includes an RRC resume request and an MT data indication (e.g., an MT-SDT resume cause, which may be a codepoint associated with an MT-SDT indication) in a msg3 communication after receiving a random access response from the network node. The network entity may then transmit a network response including a contention resolution message without an RRC message, and may subsequently transmit downlink data to the UE 120 that is scheduled by a cell radio network temporary identifier (C-RNTI) assigned to the UE 120. As further shown, subsequent data transmissions may include uplink data from the UE 120 in response to the downlink small transmission and/or more downlink data targeting the UE 120. As further shown, the network entity may transmit an RRC release message with the suspend configuration parameter enabled to terminate the uplink and/or downlink SDTs.

Alternatively, example 600B in FIG. 6B depicts a paging-triggered MT-SDT procedure in which the UE 120 responds to an MT-SDT indication carried in a paging message by initiating a two-step RA procedure (e.g., via CBRA and/or CFRA) or an MO-SDT procedure based on a two-step RA procedure. For example, as shown in FIG. 6B, the network entity may transmit an RRC release message to the UE 120 with a suspend configuration parameter enabled, which may cause the UE 120 to transition to the RRC inactive or idle state. In cases where the network entity has downlink data to transmit to the UE 120 and the downlink data has a payload size that fails to satisfy (e.g., is less than or equal to a threshold), the network entity may transmit a paging message to the UE 120 that includes an identity of the UE and an MT-SDT indication, and optionally further includes a dedicated preamble and PUSCH resource (e.g., for CFRA). In example 600B, the UE 120 may then transmit a msgA communication that includes a random access preamble and a PUSCH payload carrying an RRC resume request and an MT data indication. The network entity may then transmit a network response including a contention resolution message without an RRC message, and may subsequently transmit downlink data to the UE 120 that is scheduled by the C-RNTI assigned to the UE 120. As further shown, subsequent data transmissions may include uplink data from the UE 120 in response to the downlink small transmission and/or more downlink data targeting the UE 120. As further shown, the network entity may transmit an RRC release message with the suspend configuration parameter enabled to terminate the uplink and/or downlink SDTs.

Alternatively, example 600C in FIG. 6C depicts a paging-triggered MT-SDT procedure in which the UE 120 responds to an MT-SDT indication carried in a paging message by initiating an MO-SDT procedure based on a CG-PUSCH transmission (e.g., a CG-SDT procedure). For example, as shown in FIG. 6C, the network entity may provide a CG resource configuration in an RRC release message transmitted to the UE 120 with a suspend configuration parameter enabled, which may cause the UE 120 to transition to the RRC inactive or idle state. In cases where the network entity has downlink small data to transmit to the UE 120, the network entity may transmit a paging message to the UE 120 that includes an identity of the UE and an MT-SDT indication. In example 600C, the UE 120 may then transmit a first uplink message using a preconfigured CG-PUSCH resource, where the first uplink message may include an RRC resume request. The network entity may then transmit a network response including a dynamic grant for a new downlink transmission or a retransmission, and may subsequently transmit downlink data to the UE 120 that is scheduled by the C-RNTI assigned to the UE 120. As further shown, subsequent data transmissions may include uplink data from the UE 120 in response to the downlink small transmission and/or more downlink data targeting the UE 120. As further shown, the network entity may transmit an RRC release message with the suspend configuration parameter enabled to terminate the uplink and/or downlink SDTs.

As indicated above, FIGS. 6A-6C are provided as examples. Other examples may differ from what is described with regard to FIGS. 6A-6C.

RACH messaging associated with a RACH-based MT-SDT (as in FIGS. 6A and 6B) may use an RA resource, such as for transmission of a RACH preamble or subsequent RACH messages. “RA resource” can include a RACH message, a RACH occasion, or a combination thereof. The UE may select the RA resource from a set of configured RA resources. Some RA resources may be common RA resources, which may be configured via system information (referred to herein as first RA resources or legacy RA resources). Some RA resources may be configured for use in connection with RACH-based MO-SDT (as in FIGS. 5A and 5B) (referred to herein as RA-SDT resources, RA-MO-SDT resources, or second RA resources). It may be up to the network to configure RA resource partitioning (e.g., between the first RA resources, the second RA resources, and/or third RA resources described elsewhere herein).

SDT communication (and non-SDT communication) may utilize radio bearers (RBs), such as DRBs or SRBs. Uplink data of the UE may be referred to as uplink SDT data (if the uplink data is mapped to a DRB configured for SDT, which may be handled in MO-SDT) or as uplink non-SDT data (if the uplink data is not mapped to any DRB configured for SDT in an ongoing SDT procedure). A field nonSDT-DataIndication, of UEAssistanceInformation, may indicate uplink non-SDT data arrival at the UE. If an RA-SDT resource (e.g., a second RA resource) is selected for MT-SDT, the network may be informed of the presence of uplink data during an SDT based on the resource type selection (which may be considered an implicit indication), and thus the network may provide a larger uplink grant for the UE to report a BSR, so that the UE can be scheduled for the subsequent uplink data.

However, legacy approaches for SDT may not provide an SR resource for SDT, so a BSR cannot be sent outside of an SDT RACH transmission (e.g., Msg3 or MsgA for RA-SDT). If a legacy RA resource (e.g., a first RA resource) is selected for MT-SDT, it may be unclear to the network whether the UE has newly arrived uplink data in an ongoing MT-SDT. Furthermore, if the uplink data arrives after transmission of the SDT RACH transmission, the UE may not be capable of providing a BSR outside of the SDT RACH transmission due to the lack of an SR resource for SDT. Thus, the network may fail to provide a grant for transmission of the uplink data, thereby causing signaling overhead and latency, or requiring the UE to enter an RRC connected state for transmission of the uplink data.

Some techniques described herein provide indication of the presence of uplink data during an MT-SDT. In some aspects, the uplink data arrives prior to transmission of a Msg3 or MsgA of the MT-SDT procedure, and the indication of the presence of the uplink data can be provided via the SDT RACH transmission. In some other aspects, the uplink data arrives after the transmission of the Msg3 or MsgA, and the UE may use another form of signaling (e.g., UE assistance information, an SR, a BSR, or a combination thereof) to trigger provision of resources on which the uplink data can be transmitted. Thus, latency and signaling overhead are reduced and the UE can remain in an RRC inactive state for transmission of the uplink data by providing resources for transmission of uplink data during an MT-SDT.

A UE may be permitted to initiate an SDT (e.g., an MO-SDT) if a set of conditions associated with an MO-SDT are satisfied. The set of conditions may include one or more of: all pending data in the uplink being mapped to radio bearers configured for SDT; data volume of the pending uplink data across all radio bearers configured for SDT being less than or equal to a configurable threshold (e.g., sdt-DataVolumeThreshold); and the RSRP of the downlink pathloss reference being higher than a threshold (e.g., sdt-RSRP-Threshold). During an MT-SDT, the UE may select a first RA resource for MT-SDT, and may select a second RA resource if the set of conditions associated with MO-SDT are satisfied. For example, the UE may only select a second RA resource if the set of conditions associated with MO-SDT are satisfied.

As mentioned above, a UE may receive an indication of an MT-SDT in a paging message. Thereafter, the UE may perform an MT-SDT procedure. For example, the UE may trigger the MT-SDT after receiving the indication, and may transmit a RACH preamble and/or perform subsequent RACH communications on a selected RA resource. However, some RA resources (e.g., first RA resources described above) may not involve the UE checking a set of conditions associated with MO-SDT as a pre-condition for selecting the RA resources, whereas other RA resources (e.g., second RA resources described above) may require the UE to check the set of conditions associated with MO-SDT as a pre-condition for selecting such RA resources for the RACH preamble and/or subsequent RACH communications. Therefore, it may be unclear whether or not the UE should check the set of conditions associated with MO-SDT before transmitting an RRC resume request including the MT-SDT indication (e.g., the MT-SDT resume cause). This ambiguity may lead to failure to utilize certain SDT resources and inefficiency in configuration of RA resources. Furthermore, in some aspects, it may be unclear how the UE is to select RACH resources for MT-SDT (e.g., whether first RA resources and/or second RA resources can be used for MT-SDT), leading to ambiguity in configuration of RA resources and decreased efficacy of MT-SDT.

Some techniques described herein provide selection of RA resource for MT-SDT based at least in part on whether a set of conditions associated with MO-SDT are satisfied. For example, the UE may select the RA resource prior to transmission of an MT-SDT RACH transmission (e.g., a RACH Msg3 including an RRC resume request with an MT-SDT indication). Thus, ambiguity regarding whether to check the set of condition associated with MO-SDT prior to transmission of the MT-SDT RACH transmission is resolved, thereby improving utilization of certain SDT resources and improved efficiency in configuration of RA resources. Furthermore, some techniques described herein provide configuration of RACH resources specific to MT-SDT (referred to herein as third RA resources or RA-MT-SDT resources), which reduces ambiguity in configuration of RA resources and increases efficacy of MT-SDT.

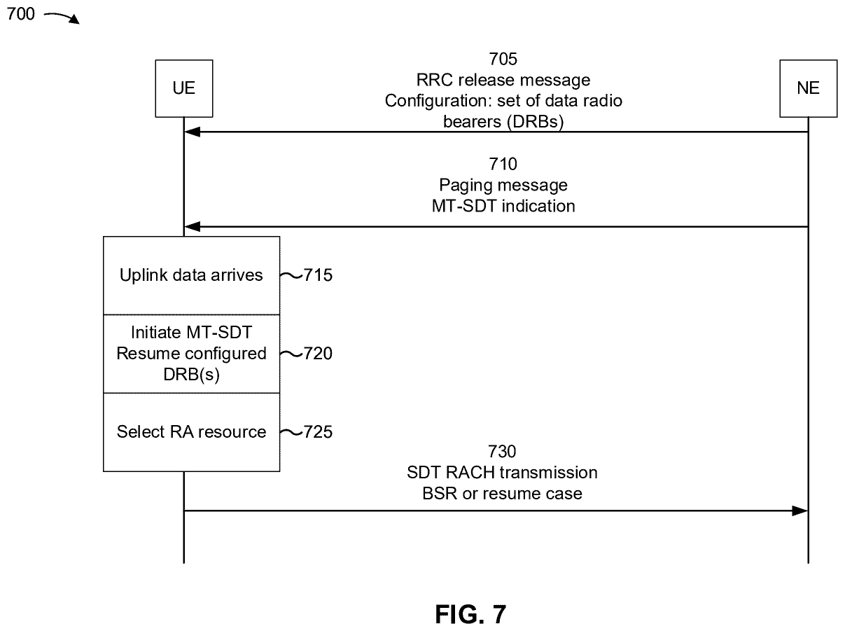

FIG. 7 is a diagram illustrating an example 700 of signaling associated with uplink data transmission in an MT-SDT, in accordance with the present disclosure. Example 700 includes a UE (e.g., UE 120) and a network entity (e.g., BS 110 or one or more components of a disaggregated base station described with regard to FIG. 3). In some aspects, example 700 may include at least part of the signaling shown in connection with FIGS. 6A, 6B, 6C, and/or 8, such as any one or more transmissions or receptions of the UE or one or more transmissions or receptions of the network entity.

As shown by reference number 705, the network entity may output, and the UE may receive, an RRC release message (e.g., the RRC release message of FIG. 5A, 5B, 5C, 6A, 6B, or 6C). As further shown, the RRC release message may include a configuration of a set of DRBs. Thus, the network entity may output, and the UE May receive, a configuration of a set of DRBs for an SDT (e.g., an MT-SDT or an MO-SDT). The configuration of the set of DRBs may include, for example, one or more SDT DRB lists. An SDT DRB list may identify one or more DRBs.

In some aspects, the set of radio bearers is usable during the MO-SDT and during the MT-SDT. For example, the configuration may include a parameter (e.g., sdt-DRB-List) that defines a joint SDT DRB list. A joint SDT DRB list may identify DRBs that are usable for reception of scheduled MT data from the network (in an MT-SDT), and for uplink data transmission by the UE. When the UE resumes a set of DRBs in connection with the MT-SDT, the UE may resume a set of bearers identified by the joint SDT DRB list.

In some aspects, the set of radio bearers is usable only during the MT-SDT. For example, the configuration may include a parameter (e.g., sdt-DRB-DL-List) that indicates a set of DRBs usable only during the MT-SDT. The parameter may be separate from a configuration of a set of DRBs usable during an MO-SDT (e.g., sdt-DRB-List). In some aspects, the set of DRBs is usable only for downlink data reception during the MT-SDT. In some other aspects, the set of radio bearers is usable for both downlink data reception (e.g., downlink data handling) and uplink data transmission (e.g., uplink data handling) in the MT-SDT. In some aspects, it may be optional for the network entity to configure the set of DRBs usable during the MO-SDT (e.g., the legacy sdt-DRB-List). Upon initiating an MT-SDT (after receiving a paging message, as described below), the UE may resume the set of DRBs usable only during the MT-SDT if all conditions associated with triggering MT-SDT are satisfied. The conditions associated with triggering MT-SDT may be different from the conditions associated with triggering MO-SDT. If the set of conditions associated with MO-SDT are satisfied, and if the set of DRBs usable during the MO-SDT are configured, the UE may also resume the set of DRBs usable during the MO-SDT. Otherwise, the UE may not resume the set of DRBs usable during the MO-SDT. For example, if the set of conditions associated with triggering MT-SDT and the set of conditions associated with triggering MO-SDT are both fulfilled, the UE may resume all DRBs including DRBs usable only during the MT-SDT and DRBs usable during the MO-SDT. In some aspects, the UE may receive an indication of DRBs to be resumed when an MT-SDT is initiated. For example, the network entity may indicate which DRBs, configured via sdt-DRB-DL-List and sdt-DRB-List (described above) are to be resumed. The UE may resume such DRBs upon initiating the MT-SDT.

As shown by reference number 710, the network entity may output, and the UE may receive, a paging message that includes an MT-SDT indication. The paging message is described in more detail in connection with FIGS. 6A-6C.

As shown by reference number 715, uplink data may arrive for transmission. In example 700, the uplink data arrives prior to an SDT RACH transmission including an RRC resume request. In example 800, described below, uplink data arrives after the SDT RACH transmission. As shown by reference number 720, the UE may initiate an MT-SDT associated with the MT-SDT indication. For example, the UE may initiate the MT-SDT based at least in part on a set of conditions associated with triggering MT-SDT being satisfied. “Initiating MT-SDT” may be used interchangeably with “triggering SDT” herein. In connection with initiating the MT-SDT, the UE may resume one or more configured DRBs (e.g., configured by the RRC release message shown by reference number 705), as described above.

For a joint SDT DRB list, if the joint SDT DRB list is configured for downlink data reception in an MT-SDT, the joint SDT DRB list may be resumed for downlink reception ONLY (in the case that uplink data is not allowed in an MT-SDT, as described below). For separate SDT DRB lists, if the DRB list indicates a set of DRBs usable during the MT-SDT and is usable for both uplink data handling and downlink data handling, the legacy DRB list (sdt-DRB-List) may not be resumed, and the set of DRBs usable during the MT-SDT may be resumed for downlink reception and uplink transmission.

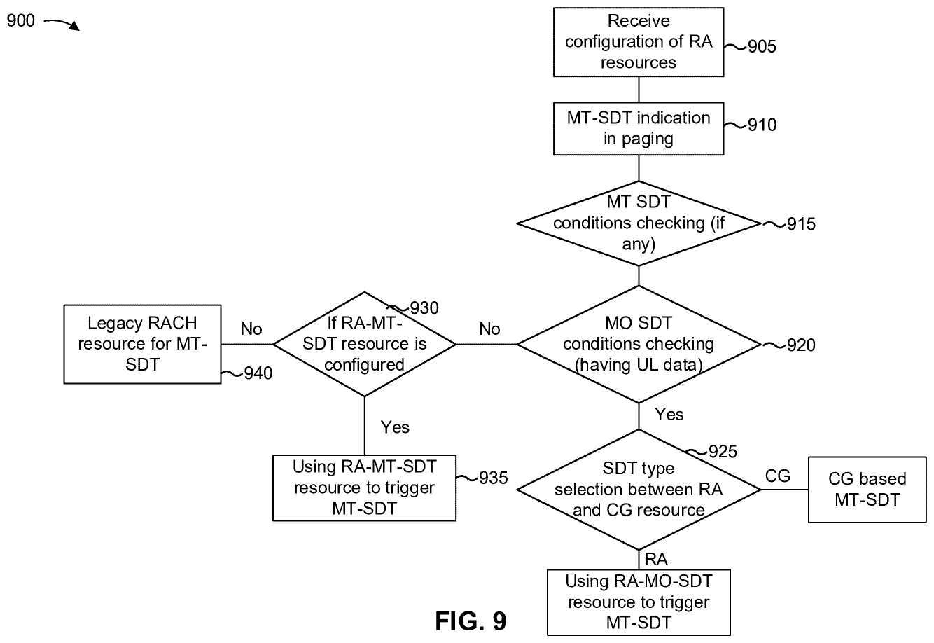

As shown by reference number 725, the UE may select an RA resource in accordance with the configuration. In some aspects, the UE may select the RA resource based at least in part on whether a set of conditions associated with MO-SDT are satisfied, as described in more detail in connection with FIG. 9. For example, the UE may select the RA resource as one of a first RA resource, a second RA resource, or a third RA resource depending on whether the set of conditions associated with MO-SDT are satisfied (and/or whether the set of conditions are checked by the UE).

In some aspects, the UE may select an RA-SDT resource (e.g., a second RA resource or a third RA resource) for the MT-SDT. In this example, an RA-SDT procedure specific to MO-SDT can be used. A mechanism for handling uplink SDT and non-SDT data may be similar to the mechanism used for uplink SDT and non-SDT data in an MO-SDT. The selected resource may provide an indication (e.g., an implicit indication) to the network entity that the network entity should provide a larger uplink grant for an MT-SDT RACH transmission (e.g., Msg3 or MsgA) for transmission of the BSR and subsequent uplink data.

In some aspects, the UE may select a legacy RA resource (e.g., a first RA resource) for the MT-SDT. In such examples, the network entity may output, and the UE may receive, an indication of whether or not uplink data transmission is permitted during an MT-SDT associated with the MT-SDT indication. In some aspects, the indication may be received in system information. In some aspects, the indication may be received in a dedicated RRC message (e.g., the RRC release message). In some aspects, the indication may be received in a paging message. If the indication indicates that if transmitting uplink data in the MT-SDT is not allowed, the arrived uplink data during MT-SDT may be transmitted during an RRC connected state, which the UE may enter after the UE completes the MT-SDT. Furthermore, if the indication indicates that if transmitting uplink data in the MT-SDT is not allowed, the UE may resume a set of radio bearers, that are usable during the MO-SDT or during the MT-SDT, for downlink reception only (as described above).

In some aspects, if the first RA resource is selected, the UE may receive, based at least in part on the selected RA resource being the first RA resource and after performing contention resolution, a grant for an uplink data transmission. For example, the UE may receive the grant without having provided a request for the grant. The UE may receive the grant so long as an uplink DRB configured for SDT is resumed when an RRC resume is initiated for the MT-SDT.

As shown by reference number 730, the UE may perform an MT-SDT RACH transmission. In some aspects, the MT-SDT RACH transmission may include a BSR based at least in part on uplink data being available for transmission during the MT-SDT. For example, the UE may transmit the BSR irrespective of whether the selected RA resource is the first RA resource, the second RA resource, or a third RA resource. Thus, no matter whether a legacy RACH resource or an RA-SDT resource is selected for MT-SDT, the UE may be allowed to transmit a BSR in Msg3 or MSGA in an MT-SDT as long as the uplink grant size in Msg3 or MSGA is large enough for the BSR. If uplink data is already available before the UE transmitting Msg3 or MSGA and if Msg3 or MSGA PUSCH is valid, the UE may report a BSR in Msg3 or MSGA in an MT-SDT.

In some aspects, the MT-SDT RACH transmission may include an RRC resume request message including a resume cause. In some aspects, the resume cause may indicate that the UE will transmit uplink data transmission and receive downlink data during the MT-SDT. For example, the resume cause may indicate that the UE will handle both arrived uplink data and downlink data in the MT-SDT. Alternatively, the resume cause may indicate that the UE will handle only downlink data during the MT-SDT. In some aspects, the resume cause may include multiple bits (e.g., a multi-bit code).

As indicated above, FIG. 7 is provided as an example. Other examples may differ from what is described with regard to FIG. 7.

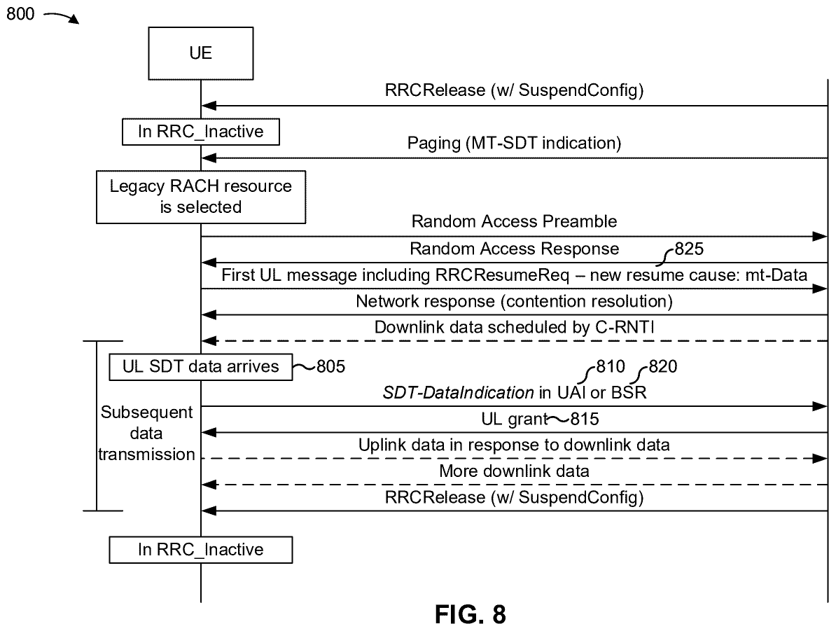

FIG. 8 is a diagram illustrating an example 800 of signaling associated with uplink data transmission in an MT-SDT, in accordance with the present disclosure. In example 800, uplink data arrives at the UE after transmission of an MT-SDT RACH transmission, as shown by reference number 805. While example 800 is described in the context of a RACH-based MT-SDT, the techniques described with regard to example 800 can also be applied for CG-based MT-SDT. In some aspects, example 800 may include at least part of the signaling shown in connection with FIGS. 6A, 6B, 6C, and/or 7, such as any one or more transmissions or receptions of the UE or one or more transmissions or receptions of the network entity.

In some aspects, the UE may transmit information indicating that the uplink data is available. In some aspects, the UE may receive a grant for an uplink data transmission based at least in part on the information. Additionally, or alternatively, the UE may transmit the information (e.g., a BSR or UE assistance information) on a resource provided by a previously received uplink grant. In some aspects, the information may include UE assistance information or a BSR, as shown by reference number 810 or 820. For example, UE assistance information (transmitted via a dedicated control channel (DCCH)) or a BSR may indicate uplink SDT data arrival in an ongoing MT-SDT. The UE assistance information may include a field (e.g., SDT-DataIndication) indicating uplink SDT data arrival during an MT-SDT. For example, the field may indicate one or more radio bearers carry the uplink SDT data, a buffer size of the one or more radio bearers, a resume cause (if provided from an upper layer such as a NAS layer), or a combination thereof. Thus, the network entity can determine whether to resume an RRC connection with the UE or keep the UE in an inactive state for further uplink or downlink data handling. The BSR reports the buffer status of the DRBs configured for SDT. In some aspects, the UE may include the field in the UE assistance information based at least in part on there being no sufficiently large grant for the UE to report a BSR. In some aspects, the network entity may provide an uplink grant in response to the UE assistance information, as shown by reference number 815. For example, the network entity may provide the uplink grant in response to receiving UE assistance information with an uplink SDT data indication in an MT-SDT. In some aspects, the network entity may provide an uplink grant based at least in part on an amount of the uplink data being lower than a threshold. For example, the network entity may determine whether to provide an uplink grant after receiving the UE assistance information.

If a legacy RACH resource is selected for performing an MT-SDT (as in FIG. 8), the UE may report a BSR (as shown by reference number 820) if uplink SDT data arrives in an ongoing MT-SDT. In some other aspects, the UE may not report a BSR. For example, neither a SR source configuration for SDT nor a valid uplink grant may be provided in a normal RACH procedure except the PUSCH resource in Msg3 or MSGA.

In some aspects, the network entity may not provide an uplink grant. For example, the network entity may transmit an RRC resume message to transition the UE to an RRC connected state for downlink data reception or uplink data transmission. In some aspects, the network entity may transmit the RRC resume message when an amount of the uplink data (as indicated, for example, by the UE assistance information, or BSR) is larger than a threshold. After receiving the UE assistance information or BSR, the network entity may provide an uplink grant (as shown in FIG. 8) or may transition the UE to a connected state, as described above.

In some aspects, the information indicating the uplink data is available may include an RRC resume request message (e.g., transmitted via a common control channel (CCCH)). For example, the UE may transmit the RRC resume request message again (in addition to an initial transmission shown by reference number 825). This transmission of the RRC resume request message may include information indicating: which radio bearers carry newly arrived uplink SDT data; a packet size for the radio bearers carrying the newly arrived uplink SDT data; which radio bearers carry newly arrived uplink non-SDT data; a packet size for the radio bearers carrying the newly arrived uplink non-SDT data; a resume cause (if provided from a higher layer such as a NAS layer); updated security key information associated with the additional transmission of the RRC resume request message; or a combination thereof.

In some aspects, the information indicating the uplink data is available may include an SR. For example, the UE may transmit the SR based at least in part on no uplink grant being available at the UE (for transmission of a BSR or UE assistance information). When the uplink data arrives at UE, the UE may transmit an SR (as an indication of availability of the uplink data) to request a first uplink grant. The UE may then transmit a BSR to report a buffer status using the first uplink grant. After the network entity receives the BSR, the network entity may provide a second uplink grant. The UE may use resources granted by the second uplink grant to transmit the arrived uplink data.

In some aspects, as long as there is an uplink grant available, the UE may transmit a BSR to report a size of data arrived during an ongoing MT-SDT.

As indicated above, FIG. 8 is provided as an example. Other examples may differ from what is described with regard to FIG. 8.

FIG. 9 is a diagram illustrating an example 900 of RA resource selection for an MT-SDT, in accordance with the present disclosure. Example 900 shows operations performed by a UE (e.g., UE 120). Signaling relating to example 900 is illustrated, for example, in FIGS. 6A-6C, 7, and 8. The example 900 of RA resource selection can be implemented as part of the call flow diagrams of FIGS. 6A-6C, 7, and/or 8.

As shown by reference number 905, the UE may receive a configuration of RA resources. For example, the UE may receive the configuration via RRC signaling. In some aspects, the configuration may indicate one or more first RA resources (e.g., legacy RA resources). In some aspects, the configuration may indicate one or more second RA resources (e.g., RA-SDT resources). In some aspects, the configuration may indicate one or more third RA resources (e.g., an RA-MT-SDT resource), which may be dedicated for MT-SDT. A third RA resource may include a RACH occasion resource, an RA preamble resource, or a combination thereof. If the UE selects a third RA resource for an MT-SDT, it may indicate (implicitly, to a network entity) that no uplink data is stored in a buffer of the UE when the UE triggers an MT-SDT. The network entity may configure RA resource partitioning between first RA resources, second RA resources, and third RA resources.

As shown by reference number 910, the UE may receive an indication of an MT-SDT in a paging message, as described with regard to FIGS. 6A-6C, 7, and 8.

As shown by reference number 915, in some aspects, the UE may check a set of conditions associated with MT-SDT. The set of conditions associated with MT-SDT may define one or more conditions that, if satisfied, allow or cause the UE to trigger the MT-SDT associated with the indication of the MT-SDT. In some aspects, the UE may not check a set of conditions associated with MT-SDT.

As shown by reference number 920, in some aspects, the UE may check a set of conditions associated with MO-SDT. In example 900, the UE checks the set of conditions associated with MO-SDT. For example, the UE may check the set of conditions associated with MO-SDT prior to an RRC resume request being initiated for MT-SDT and after an MT_SDT indication is received in a paging message. In some other aspects, the UE does not check the set of conditions associated with MO-SDT. In some aspects, the UE may check the set of conditions associated with MO-SDT after MT-SDT is triggered and if pending uplink data is available at the UE. In some aspects, the UE may always check the set of conditions associated with MO-SDT when MT-SDT is triggered (e.g., irrespective of whether pending uplink data is available at the UE). In some aspects, the UE may receive information (via a network configuration such as system information, via a dedicated RRC message such as an RRC release message, or via the paging message) indicating whether or not to check the set of conditions associated with MO-SDT. The set of conditions associated with MO-SDT may include at least whether pending uplink data is mapped to one or more SDT radio bearers, whether uplink data volume of the uplink data is below a configured threshold, and whether a downlink RSRP is above a configured threshold.

If the set of conditions associated with MO-SDT are checked and are satisfied (reference number 920—Yes), then the UE may perform an SDT type selection between an RA resource (as in FIGS. 6A-6B) and a CG resource (as in FIG. 6C), as shown by reference number 925. If the UE selects an RA resource (reference number 925-RA), then the UE may select a second RA resource (e.g., an RA-MO-SDT resource) on which to trigger the MT-SDT. Thus, if all MO-SDT conditions are fulfilled, the UE may be allowed to use an RA-MO-SDT resource (if configured) to perform MT-SDT. For example, the UE may select the second RA resource based at least in part on the set of conditions associated with MO-SDT being satisfied. If the UE selects a CG resource (reference number 925-CG), then the UE may perform a CG-based MT-SDT, as in FIG. 6C.

In some aspects, the set of conditions associated with MO-SDT may not be satisfied or may not be checked (reference number 920—No). If a set of third RA resources (e.g., RA-MT-SDT resources) are configured (reference number 930—Yes), then the UE may select a third RA resource, and may use the third RA resource to trigger an MT-SDT (reference number 935). If a set of third RA resources are not configured (reference number 930—No), then the UE may select a first RA resource, and may use the first RA resource to trigger an MT-SDT. If neither second RA resources nor third RA resources are configured for the UE, then the UE may perform the MT-SDT using first RA resources (e.g., legacy RACH resources), as shown by reference number 940.

In some aspects, the UE may be permitted to select a second RA resource if the UE does not check the set of conditions associated with MO-SDT. For example, even if the UE does not check the MO-SDT conditions, the UE can still use the RA-MO-SDT resource to perform MT-SDT. This may imply that the network entity allows the UE to transmit any size of uplink data during the MT-SDT procedure. In some other aspects (as described above), the UE may not be allowed to use an RA-SDT resource (e.g., a second RA resource or a third RA resource) if the UE does not check the set of conditions associated with MO-SDT (e.g., the UE may select only a first RA resource). In some aspects, the UE may receive signaling (e.g., the paging message or another form of signaling) indicating which type(s) of RA resource (out of the first RA resource, the second RA resource, or the third RA resource) can be selected by the UE.

In some aspects, the UE may not be permitted to transmit uplink small data (e.g., uplink data of which an uplink data volume is lower than a threshold, or uplink data on an SDT DRB) during an MT-SDT procedure if the UE does not check the set of conditions associated with MO-SDT. In this example, arrived uplink data during an ongoing MT-SDT may be transmitted in an RRC connected state (after the UE completes the MT-SDT). Alternatively, in some aspects, the UE may be permitted to transmit uplink small data during an MT-SDT procedure. In such examples, the network entity may transmit an uplink grant for the uplink small data at or after contention resolution.

In some aspects, the UE may transmit an RRC resume request during the MT-SDT, as described above. In such aspects, the UE may provide an MT-SDT resume cause, no matter using which type of RACH resource is selected. For example, the UE may always provide the MT-SDT resume cause in the RRC resume request. The MT-SDT resume cause may inform the network entity of the purpose of the RRC resume request (e.g., MT-SDT). If an RA-MO-SDT resource is selected for the MT-SDT, UE may transmit the uplink small data or may report a BSR in Msg3 or MSGA.

As indicated above, FIG. 9 is provided as an example. Other examples may differ from what is described with regard to FIG. 9.

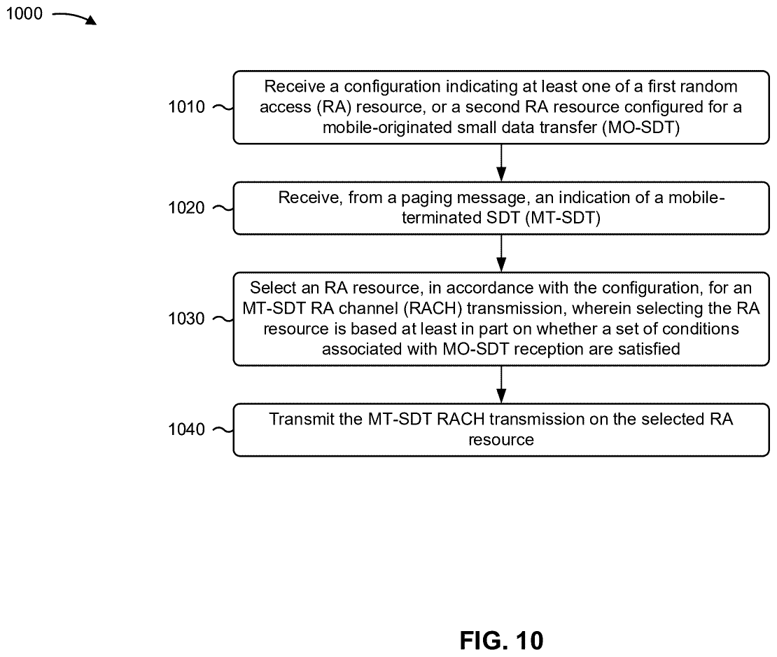

FIG. 10 shows a method 1000 for wireless communications by a UE, such as UE 120.

Method 1000 begins at 1010 with receiving a configuration indicating at least one of: a first RA resource, or a second RA resource configured for a MO-SDT.

Method 1000 then proceeds to step 1020 with receiving, from a paging message, an indication of a MT-SDT.

Method 1000 then proceeds to step 1030 with selecting an RA resource, in accordance with the configuration, for an MT-SDT RACH transmission, wherein selecting the RA resource is based at least in part on whether a set of conditions associated with MO-SDT reception are satisfied.

Method 1000 then proceeds to step 1040 with transmitting the MT-SDT RACH transmission on the selected RA resource.

In a first aspect, method 1000 includes determining whether the set of conditions associated with MO-SDT reception are satisfied.

In a second aspect, alone or in combination with the first aspect, determining whether the set of conditions associated with MO-SDT reception are satisfied further comprises determining, in response to pending uplink data being available, whether the set of conditions associated with MO-SDT reception are satisfied.

In a third aspect, alone or in combination with one or more of the first and second aspects, method 1000 includes determining, based at least in part on the signaling, whether the set of conditions associated with MO-SDT reception are satisfied.

In a fourth aspect, alone or in combination with one or more of the first through third aspects, determining whether the set of conditions associated with MO-SDT reception are satisfied further comprises determining, prior to transmitting a radio resource control resume request message for an MT-SDT, whether the set of conditions associated with MO-SDT reception are satisfied.

In a fifth aspect, alone or in combination with one or more of the first through fourth aspects, the set of conditions associated with MO-SDT reception include one or more of pending uplink data is mapped to an SDT radio bearer, uplink data volume is smaller than a first threshold, or a downlink reference signal received power is greater than a second threshold.

In a sixth aspect, alone or in combination with one or more of the first through fifth aspects, the configuration indicates a third RA resource configured for the MT-SDT, wherein selecting the selected RA resource further comprises selecting the selected RA resource from at least the first RA resource, the second RA resource, or the third RA resource.

In a seventh aspect, alone or in combination with one or more of the first through sixth aspects, selecting the selected RA resource further comprises selecting the second RA resource as the selected RA resource based at least in part on a set of conditions associated with MO-SDT reception being satisfied.

In an eighth aspect, alone or in combination with one or more of the first through seventh aspects, selecting the selected RA resource further comprises selecting the third RA resource as the selected RA resource based at least in part on a set of conditions associated with MO-SDT reception not being satisfied.

In a ninth aspect, alone or in combination with one or more of the first through eighth aspects, method 1000 includes transmitting an RRC resume request message for the MT-SDT, wherein the RRC resume request message includes an MT-SDT resume cause.

In a tenth aspect, alone or in combination with one or more of the first through ninth aspects, the selected RA resource is one of the first RA resource, the second RA resource, or a third RA resource configured for the MT-SDT.

In an eleventh aspect, alone or in combination with one or more of the first through tenth aspects, method 1000 includes receiving signaling indicating a set of RA resources, including at least the first RA resource and the second RA resource and the third RA resource, from which the selected RA resource is selected.

In a twelfth aspect, alone or in combination with one or more of the first through eleventh aspects, method 1000 includes performing an uplink data transmission after the MT-SDT, wherein the uplink data transmission is not permitted during the MT-SDT.

In a thirteenth aspect, alone or in combination with one or more of the first through twelfth aspects, method 1000 includes performing an uplink data transmission during the MT-SDT.

In a fourteenth aspect, alone or in combination with one or more of the first through thirteenth aspects, method 1000 includes receiving a grant for the uplink data transmission at or after a contention resolution associated with the MT-SDT RACH transmission.

In a fifteenth aspect, alone or in combination with one or more of the first through fourteenth aspects, method 1000 includes receiving a configuration of a set of radio bearers for an SDT.

In a sixteenth aspect, alone or in combination with one or more of the first through fifteenth aspects, the set of radio bearers is usable during the MO-SDT and during the MT-SDT.

In a seventeenth aspect, alone or in combination with one or more of the first through sixteenth aspects, the set of radio bearers is usable only during the MT-SDT.

In an eighteenth aspect, alone or in combination with one or more of the first through seventeenth aspects, the set of radio bearers is usable only for downlink data reception.

In a nineteenth aspect, alone or in combination with one or more of the first through eighteenth aspects, the set of radio bearers is usable for both downlink data reception and uplink data transmission.

In a twentieth aspect, alone or in combination with one or more of the first through nineteenth aspects, method 1000 includes resuming one or more radio bearers of the set of radio bearers based at least in part on the indication, wherein the activating is based at least in part on a set of conditions associated with the set of radio bearers being satisfied.

In a twenty-first aspect, alone or in combination with one or more of the first through twentieth aspects, method 1000 includes receiving an indication of one or more selected radio bearers of the set of radio bearers, and resuming the one or more selected radio bearers based at least in part on the indication and a set of conditions associated with the set of radio bearers being satisfied.

In a twenty-second aspect, alone or in combination with one or more of the first through twenty-first aspects, the selected RA resource is the first RA resource, wherein the method further comprises receiving an indication of whether uplink data transmission is permitted during the MT-SDT.

In a twenty-third aspect, alone or in combination with one or more of the first through twenty-second aspects, the indication indicates that uplink data transmission is not permitted during the MT-SDT, wherein the method further comprises resuming a set of radio bearers, that are usable during the MO-SDT and during the MT-SDT, for downlink reception only.

In a twenty-fourth aspect, alone or in combination with one or more of the first through twenty-third aspects, the selected RA resource is the first RA resource, wherein the method further comprises receiving, based at least in part on the selected RA resource being the first RA resource and after performing contention resolution, a grant for an uplink data transmission.

In a twenty-fifth aspect, alone or in combination with one or more of the first through twenty-fourth aspects, receiving the grant further comprises receiving the grant without having provided a request for the grant.

In a twenty-sixth aspect, alone or in combination with one or more of the first through twenty-fifth aspects, method 1000 includes transmitting, via the MT-SDT RACH transmission or another RACH transmission and based at least in part on uplink data being available for transmission during the MT-SDT, a buffer status report.

In a twenty-seventh aspect, alone or in combination with one or more of the first through twenty-sixth aspects, transmitting the buffer status report comprises transmitting the buffer status report irrespective of whether the selected RA resource is the first RA resource, the second RA resource, or a third RA resource.

In a twenty-eighth aspect, alone or in combination with one or more of the first through twenty-seventh aspects, method 1000 includes transmitting a radio resource control resume request message, wherein the radio resource control resume request message includes a resume cause.

In a twenty-ninth aspect, alone or in combination with one or more of the first through twenty-eighth aspects, the resume cause indicates that the UE will transmit uplink data transmission and receive downlink data during the MT-SDT.

In a thirtieth aspect, alone or in combination with one or more of the first through twenty-ninth aspects, method 1000 includes transmitting, based at least in part on uplink data being available for transmission during the MT-SDT, information indicating that the uplink data is available.

In a thirty-first aspect, alone or in combination with one or more of the first through thirtieth aspects, method 1000 includes receiving a grant for an uplink data transmission based at least in part on the information.

In a thirty-second aspect, alone or in combination with one or more of the first through thirty-first aspects, the information includes at least one of assistance information or a buffer status report.

In a thirty-third aspect, alone or in combination with one or more of the first through thirty-second aspects, method 1000 includes transmitting an RRC resume request message for an MT-SDT, wherein the RRC resume request message includes an indication that uplink data is available for transmission during the MT-SDT.

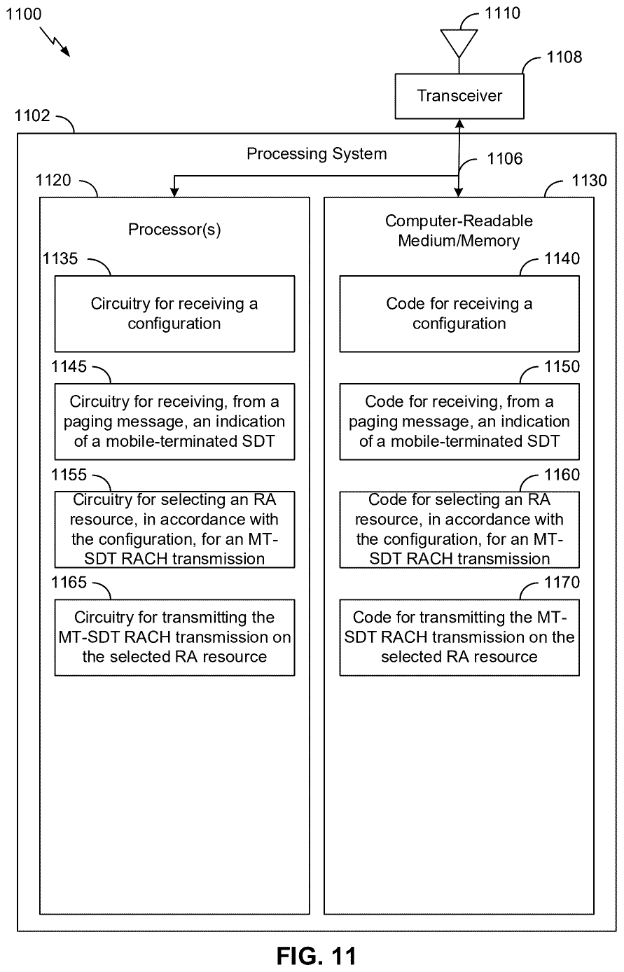

In one aspect, method 1000, or any aspect related to it, may be performed by an apparatus, such as communications device 1100 of FIG. 11, which includes various components operable, configured, or adapted to perform the method 1000. Communications device 1100 is described below in further detail.

Note that FIG. 10 is just one example of a method, and other methods including fewer, additional, or alternative steps are possible consistent with this disclosure.

FIG. 11 is a diagram illustrating an example of an implementation of code and circuitry for a communications device 1100, in accordance with the present disclosure. The communications device 1100 may be a UE, or a UE may include the communications device 1100.

The communications device 1100 includes a processing system 1102 coupled to a transceiver 1108 (e.g., a transmitter and/or a receiver). The transceiver 1108 is configured to transmit and receive signals for the communications device 1100 via an antenna 1110, such as the various signals as described herein. The processing system 1102 may be configured to perform processing functions for the communications device 1100, including processing signals received and/or to be transmitted by the communications device 1100.

The processing system 1102 includes one or more processors 1120. In various aspects, the one or more processors 1120 may be representative of one or more of receive processor 258, transmit processor 264, TX MIMO processor 266, and/or controller/processor 280, as described with respect to FIG. 2. The one or more processors 1120 are coupled to a computer-readable medium/memory 1130 via a bus 1106. In various aspects, the computer-readable medium/memory 1130 may be representative of memory 282, as described with respect to FIG. 2. In certain aspects, the computer-readable medium/memory 1130 is configured to store instructions (e.g., computer-executable code, processor-executable code) that when executed by the one or more processors 1120, cause the one or more processors 1120 to perform the method 1000 described with respect to FIG. 10, or any aspect related to it. Note that reference to a processor performing a function of communications device 1100 may include one or more processors performing that function of communications device 1100.

As shown in FIG. 11, the communications device 1100 may include circuitry for receiving a configuration (circuitry 1135).

As shown in FIG. 11, the communications device 1100 may include, stored in computer-readable medium/memory 1130, code for receiving a configuration (code 1140).

As shown in FIG. 11, the communications device 1100 may include circuitry for receiving, from a paging message, an indication of a MT-SDT (circuitry 1145).

As shown in FIG. 11, the communications device 1100 may include, stored in computer-readable medium/memory 1130, code for receiving, from a paging message, an indication of a MT-SDT (code 1150).

As shown in FIG. 11, the communications device 1100 may include circuitry for selecting an RA resource, in accordance with the configuration, for an MT-SDT RACH transmission (circuitry 1155).

As shown in FIG. 11, the communications device 1100 may include, stored in computer-readable medium/memory 1130, code for selecting an RA resource, in accordance with the configuration, for an MT-SDT RACH transmission (code 1160).

As shown in FIG. 11, the communications device 1100 may include circuitry for transmitting the MT-SDT RACH transmission on the selected RA resource (circuitry 1165).

As shown in FIG. 11, the communications device 1100 may include, stored in computer-readable medium/memory 1130, code for transmitting the MT-SDT RACH transmission on the selected RA resource (code 1170).

Various components of the communications device 1100 may provide means for performing the method 1000 described with respect to FIG. 10, or any aspect related to it. For example, means for transmitting, sending, or outputting for transmission may include the transceiver(s) 254 and/or antenna(s) 252 of the UE 120 and/or transceiver 1108 and antenna 1110 of the communications device 1100 in FIG. 11. Means for receiving or obtaining may include the transceiver(s) 254 and/or antenna(s) 252 of the UE 120 and/or transceiver 1108 and antenna 1110 of the communications device 1100 in FIG. 11.

FIG. 11 is provided as an example. Other examples may differ from what is described in connection with FIG. 11.

The following provides an overview of some Aspects of the present disclosure:

Aspect 1: A method of wireless communication performed by a user equipment (UE), comprising: receiving a configuration indicating at least one of: a first random access (RA) resource, or a second RA resource configured for a mobile-originated small data transfer (MO-SDT); receiving, from a paging message, an indication of a mobile-terminated SDT (MT-SDT); selecting an RA resource, in accordance with the configuration, for an MT-SDT RA channel (RACH) transmission, wherein selecting the RA resource is based at least in part on whether a set of conditions associated with MO-SDT reception are satisfied; and transmitting the MT-SDT RACH transmission on the selected RA resource.

Aspect 2: The method of Aspect 1, further comprising determining whether the set of conditions associated with MO-SDT reception are satisfied.

Aspect 3: The method of Aspect 2, wherein determining whether the set of conditions associated with MO-SDT reception are satisfied further comprises determining, in response to pending uplink data being available, whether the set of conditions associated with MO-SDT reception are satisfied.

Aspect 4: The method of Aspect 2, further comprising receiving signaling indicating to determine whether the set of conditions associated with MO-SDT reception are satisfied, wherein determining whether the set of conditions associated with MO-SDT reception are satisfied further comprises determining, based at least in part on the signaling, whether the set of conditions associated with MO-SDT reception are satisfied.

Aspect 5: The method of Aspect 2, wherein determining whether the set of conditions associated with MO-SDT reception are satisfied further comprises determining, prior to transmitting a radio resource control resume request message for an MT-SDT, whether the set of conditions associated with MO-SDT reception are satisfied.

Aspect 6: The method of any of Aspects 1-5, wherein the set of conditions associated with MO-SDT reception include one or more of: pending uplink data is mapped to an SDT radio bearer, uplink data volume is smaller than a first threshold, or a downlink reference signal received power is greater than a second threshold.

Aspect 7: The method of any of Aspects 1-6, wherein the configuration indicates a third RA resource configured for the MT-SDT, and wherein selecting the selected RA resource further comprises selecting the selected RA resource from at least the first RA resource, the second RA resource, or the third RA resource.

Aspect 8: The method of Aspect 7, wherein selecting the selected RA resource further comprises: selecting the second RA resource as the selected RA resource based at least in part on a set of conditions associated with MO-SDT reception being satisfied.

Aspect 9: The method of Aspect 7, wherein selecting the selected RA resource further comprises: selecting the third RA resource as the selected RA resource based at least in part on a set of conditions associated with MO-SDT reception not being satisfied.

Aspect 10: The method of any of Aspects 1-9, further comprising transmitting a radio resource control (RRC) resume request message for the MT-SDT, wherein the RRC resume request message includes an MT-SDT resume cause.

Aspect 11: The method of Aspect 10, wherein the selected RA resource is one of the first RA resource, the second RA resource, or a third RA resource configured for the MT-SDT.

Aspect 12: The method of Aspect 11, further comprising receiving signaling indicating a set of RA resources, including at least the first RA resource and the second RA resource and the third RA resource, from which the selected RA resource is selected.

Aspect 13: The method of any of Aspects 1-12, further comprising: performing an uplink data transmission after the MT-SDT, wherein the uplink data transmission is not permitted during the MT-SDT.

Aspect 14: The method of any of Aspects 1-13, further comprising performing an uplink data transmission during the MT-SDT.

Aspect 15: The method of Aspect 14, further comprising receiving a grant for the uplink data transmission at or after a contention resolution associated with the MT-SDT RACH transmission.

Aspect 16: The method of any of Aspects 1-15, further comprising receiving a configuration of a set of radio bearers for an SDT.

Aspect 17: The method of Aspect 16, wherein the set of radio bearers is usable during the MO-SDT and during the MT-SDT.

Aspect 18: The method of Aspect 16, wherein the set of radio bearers is usable only during the MT-SDT.

Aspect 19: The method of Aspect 18, wherein the set of radio bearers is usable only for downlink data reception.

Aspect 20: The method of Aspect 18, wherein the set of radio bearers is usable for both downlink data reception and uplink data transmission.

Aspect 21: The method of Aspect 16, further comprising resuming one or more radio bearers of the set of radio bearers based at least in part on the indication, wherein the activating is based at least in part on a set of conditions associated with the set of radio bearers being satisfied.

Aspect 22: The method of Aspect 16, further comprising receiving an indication of one or more selected radio bearers of the set of radio bearers; and resuming the one or more selected radio bearers based at least in part on the indication and a set of conditions associated with the set of radio bearers being satisfied.

Aspect 23: The method of any of Aspects 1-22, wherein the selected RA resource is the first RA resource, and wherein the method further comprises receiving an indication of whether uplink data transmission is permitted during the MT-SDT.

Aspect 24: The method of Aspect 23, wherein the indication indicates that uplink data transmission is not permitted during the MT-SDT, and wherein the method further comprises: resuming a set of radio bearers, that are usable during the MO-SDT and during the MT-SDT, for downlink reception only.

Aspect 25: The method of any of Aspects 1-24, wherein the selected RA resource is the first RA resource, and wherein the method further comprises receiving, based at least in part on the selected RA resource being the first RA resource and after performing contention resolution, a grant for an uplink data transmission.

Aspect 26: The method of Aspect 25, wherein receiving the grant further comprises receiving the grant without having provided a request for the grant.

Aspect 27: The method of any of Aspects 1-26, further comprising: transmitting, via the MT-SDT RACH transmission or another RACH transmission and based at least in part on uplink data being available for transmission during the MT-SDT, a buffer status report.

Aspect 28: The method of Aspect 27, wherein transmitting the buffer status report comprises transmitting the buffer status report irrespective of whether the selected RA resource is the first RA resource, the second RA resource, or a third RA resource.

Aspect 29: The method of any of Aspects 1-28, further comprising: transmitting a radio resource control resume request message, wherein the radio resource control resume request message includes a resume cause.

Aspect 30: The method of Aspect 29, wherein the resume cause indicates that the UE will transmit uplink data transmission and receive downlink data during the MT-SDT.

Aspect 31: The method of any of Aspects 1-30, further comprising transmitting, based at least in part on uplink data being available for transmission during the MT-SDT, information indicating that the uplink data is available.

Aspect 32: The method of Aspect 31, further comprising receiving a grant for an uplink data transmission based at least in part on the information.

Aspect 33: The method of Aspect 31, wherein the information includes at least one of assistance information or a buffer status report.

Aspect 34: The method of any of Aspects 1-33, further comprising transmitting a radio resource control (RRC) resume request message for an MT-SDT, wherein the RRC resume request message includes an indication that uplink data is available for transmission during the MT-SDT.

Aspect 35: An apparatus for wireless communication at a device, comprising a processor; memory coupled with the processor; and instructions stored in the memory and executable by the processor to cause the apparatus to perform the method of one or more of Aspects 1-34.

Aspect 36: A device for wireless communication, comprising a memory and one or more processors coupled to the memory, the one or more processors configured to perform the method of one or more of Aspects 1-34.

Aspect 37: An apparatus for wireless communication, comprising at least one means for performing the method of one or more of Aspects 1-34.

Aspect 38: A non-transitory computer-readable medium storing code for wireless communication, the code comprising instructions executable by a processor to perform the method of one or more of Aspects 1-34.

Aspect 39: A non-transitory computer-readable medium storing a set of instructions for wireless communication, the set of instructions comprising one or more instructions that, when executed by one or more processors of a device, cause the device to perform the method of one or more of Aspects 1-34.

The foregoing disclosure provides illustration and description but is not intended to be exhaustive or to limit the aspects to the precise forms disclosed. Modifications and variations may be made in light of the above disclosure or may be acquired from practice of the aspects.

As used herein, the term “component” is intended to be broadly construed as hardware and/or a combination of hardware and software. “Software” shall be construed broadly to mean instructions, instruction sets, code, code segments, program code, programs, subprograms, software modules, applications, software applications, software packages, routines, subroutines, objects, executables, threads of execution, procedures, and/or functions, among other examples, whether referred to as software, firmware, middleware, microcode, hardware description language, or otherwise. As used herein, a “processor” is implemented in hardware and/or a combination of hardware and software. It will be apparent that systems and/or methods described herein may be implemented in different forms of hardware and/or a combination of hardware and software. The actual specialized control hardware or software code used to implement these systems and/or methods is not limiting of the aspects. Thus, the operation and behavior of the systems and/or methods are described herein without reference to specific software code, since those skilled in the art will understand that software and hardware can be designed to implement the systems and/or methods based, at least in part, on the description herein.

As used herein, “satisfying a threshold” may, depending on the context, refer to a value being greater than the threshold, greater than or equal to the threshold, less than the threshold, less than or equal to the threshold, equal to the threshold, not equal to the threshold, or the like.

Even though particular combinations of features are recited in the claims and/or disclosed in the specification, these combinations are not intended to limit the disclosure of various aspects. Many of these features may be combined in ways not specifically recited in the claims and/or disclosed in the specification. The disclosure of various aspects includes each dependent claim in combination with every other claim in the claim set. As used herein, a phrase referring to “at least one of” a list of items refers to any combination of those items, including single members. As an example, “at least one of: a, b, or c” is intended to cover a, b, c, a+b, a+c, b+c, and a+b+c, as well as any combination with multiples of the same element (e.g., a+a, a+a+a, a+a+b, a+a+c, a+b+b, a+c+c, b+b, b+b+b, b+b+c, c+c, and c+c+c, or any other ordering of a, b, and c).

No element, act, or instruction used herein should be construed as critical or essential unless explicitly described as such. Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Furthermore, as used herein, the terms “set” and “group” are intended to include one or more items and may be used interchangeably with “one or more.” Where only one item is intended, the phrase “only one” or similar language is used. Also, as used herein, the terms “has,” “have,” “having,” or the like are intended to be open-ended terms that do not limit an element that they modify (e.g., an element “having” A may also have B). Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

The preceding description is provided to enable any person skilled in the art to practice the various aspects described herein. The examples discussed herein are not limiting of the scope, applicability, or aspects set forth in the claims. Various modifications to these aspects will be readily apparent to those skilled in the art, and the general principles defined herein may be applied to other aspects. For example, changes may be made in the function and arrangement of elements discussed without departing from the scope of the disclosure. Various examples may omit, substitute, or add various procedures or components as appropriate. For instance, the methods described may be performed in an order different from that described, and various actions may be added, omitted, or combined. Also, features described with respect to some examples may be combined in some other examples. For example, an apparatus may be implemented or a method may be practiced using any number of the aspects set forth herein. In addition, the scope of the disclosure is intended to cover such an apparatus or method that is practiced using other structure, functionality, or structure and functionality in addition to, or other than, the various aspects of the disclosure set forth herein. It should be understood that any aspect of the disclosure disclosed herein may be embodied by one or more elements of a claim.

The various illustrative logical blocks, modules, and circuits described in connection with the present disclosure may be implemented or performed with a general purpose processor, a digital signal processor (DSP), an application-specific integrated circuit (ASIC), a field programmable gate array (FPGA) or other programmable logic device (PLD), discrete gate or transistor logic, discrete hardware components, or any combination thereof designed to perform the functions described herein. A general-purpose processor may be a microprocessor, but in the alternative, the processor may be any commercially available processor, controller, microcontroller, or state machine. A processor may also be implemented as a combination of computing devices (e.g., a combination of a DSP and a microprocessor, a plurality of microprocessors, one or more microprocessors in conjunction with a DSP core, a system on a chip (SoC), or any other such configuration).

As used herein, the term “determining” encompasses a wide variety of actions. For example, “determining” may include calculating, computing, processing, deriving, investigating, looking up (e.g., looking up in a table, a database, or another data structure), ascertaining, and the like. Also, “determining” may include receiving (e.g., receiving information), accessing (e.g., accessing data in a memory), and the like. Also, “determining” may include resolving, selecting, choosing, establishing, and the like.

The methods disclosed herein comprise one or more actions for achieving the methods. The method actions may be interchanged with one another without departing from the scope of the claims. In other words, unless a specific order of actions is specified, the order and/or use of specific actions may be modified without departing from the scope of the claims. Further, the various operations of methods described above may be performed by any suitable means capable of performing the corresponding functions. The means may include various hardware and/or software component(s) and/or module(s), including, but not limited to a circuit, an application specific integrated circuit (ASIC), or a processor.

The following claims are not intended to be limited to the aspects shown herein, but are to be accorded the full scope consistent with the language of the claims. Within a claim, reference to an element in the singular is not intended to mean “one and only one” unless specifically so stated, but rather “one or more.” Unless specifically stated otherwise, the term “some” refers to one or more. No claim element is to be construed under the provisions of 35 U.S.C. § 112 (f) unless the element is expressly recited using the phrase “means for”. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims.

1. A user equipment (UE) for wireless communication, comprising:
a memory; and
one or more processors, coupled to the memory, configured to:
receive a configuration indicating at least one of:
a first random access (RA) resource, or
a second RA resource configured for a mobile-originated small data transfer (MO-SDT);
receive, from a paging message, an indication of a mobile-terminated SDT (MT-SDT);
select an RA resource, in accordance with the configuration, for an MT-SDT RA channel (RACH) transmission, wherein selecting the RA resource is based at least in part on whether a set of conditions associated with MO-SDT reception are satisfied; and
transmit the MT-SDT RACH transmission on the selected RA resource.

2. The UE of claim 1, wherein the one or more processors are further configured to determine whether the set of conditions associated with MO-SDT reception are satisfied.

3. The UE of claim 2, wherein the one or more processors, to determine whether the set of conditions associated with MO-SDT reception are satisfied, are configured to:
determine, in response to pending uplink data being available, whether the set of conditions associated with MO-SDT reception are satisfied; or
determine, prior to transmitting a radio resource control resume request message for an MT-SDT, whether the set of conditions associated with MO-SDT reception are satisfied.

4. The UE of claim 2, wherein the one or more processors are further configured to receive signaling indicating to determine whether the set of conditions associated with MO-SDT reception are satisfied, wherein, to determine whether the set of conditions associated with MO-SDT reception are satisfied, the one or more processors are further configured to determine, based at least in part on the signaling, whether the set of conditions associated with MO-SDT reception are satisfied.

5. (canceled)

6. The UE of claim 1, wherein the set of conditions associated with MO-SDT reception include one or more of:
pending uplink data is mapped to an SDT radio bearer,
uplink data volume is smaller than a first threshold, or
a downlink reference signal received power is greater than a second threshold.

7. The UE of claim 1, wherein the configuration indicates a third RA resource configured for the MT-SDT, and wherein the one or more processors, to select the selected RA resource, are configured to select the selected RA resource from at least the first RA resource, the second RA resource, or the third RA resource.

8. The UE of claim 7, wherein the one or more processors, to select the selected RA resource, are configured to:
select the second RA resource as the selected RA resource based at least in part on a set of conditions associated with MO-SDT reception being satisfied; or
select the third RA resource as the selected RA resource based at least in part on a set of conditions associated with MO-SDT reception not being satisfied.

9. (canceled)

10. The UE of claim 1, wherein the one or more processors are further configured to transmit a radio resource control (RRC) resume request message for the MT-SDT, wherein the RRC resume request message includes an MT-SDT resume cause.

11. (canceled)

12. (canceled)

13. The UE of claim 1, wherein the one or more processors are further configured to:
perform an uplink data transmission after the MT-SDT, wherein the uplink data transmission is not permitted during the MT-SDT.

14. The UE of claim 1, wherein the one or more processors are further configured to perform an uplink data transmission during the MT-SDT.

15. (canceled)

16. The UE of claim 1, wherein the one or more processors are further configured to receive a configuration of a set of radio bearers for an SDT.

17. (canceled)

18. The UE of claim 16, wherein the set of radio bearers is usable during the MO-SDT and during the MT-SDT, or wherein the set of radio bearers is usable only during the MT-SDT.

19. The UE of claim 18, wherein the set of radio bearers is usable only during the MT-SDT, and wherein:
the set of radio bearers is usable only for downlink data reception; or
the set of radio bearers is usable for both downlink data reception and uplink data transmission.

20. (canceled)

21. The UE of claim 16, wherein the one or more processors are further configured to resume one or more radio bearers of the set of radio bearers based at least in part on the indication, wherein the resumption is based at least in part on a set of conditions associated with the set of radio bearers being satisfied.

22. The UE of claim 1, wherein the selected RA resource is the first RA resource, and wherein the one or more processors are configured to:
receive an indication of whether uplink data transmission is permitted during the MT-SDT; or
receive, based at least in part on the selected RA resource being the first RA resource and after performing contention resolution, a grant for transmitting uplink data.

23. (canceled)

24. The UE of claim 1, wherein the one or more processors are further configured to:
transmit, via the MT-SDT RACH transmission or another RACH transmission and based at least in part on uplink data being available for transmission during the MT-SDT, a buffer status report.

25. The UE of claim 1, wherein the one or more processors are further configured to:
transmit a radio resource control resume request message, wherein the radio resource control resume request message includes a resume cause.

26. The UE of claim 1, wherein the one or more processors are further configured to transmit, based at least in part on uplink data being available for transmission during the MT-SDT, information indicating that the uplink data is available.

27. The UE of claim 1, wherein the one or more processors are further configured to transmit a radio resource control (RRC) resume request message for an MT-SDT, wherein the RRC resume request message includes an indication that uplink data is available for transmission during the MT-SDT.

28. A method of wireless communication performed by a user equipment (UE), comprising:
receiving a configuration indicating at least one of:
a first random access (RA) resource, or
a second RA resource configured for a mobile-originated small data transfer (MO-SDT);
receiving, from a paging message, an indication of a mobile-terminated SDT (MT-SDT);
selecting an RA resource, in accordance with the configuration, for an MT-SDT RA channel (RACH) transmission, wherein selecting the RA resource is based at least in part on whether a set of conditions associated with MO-SDT reception are satisfied; and
transmitting the MT-SDT RACH transmission on the selected RA resource.

29. (canceled)

30. (canceled)
